(19) United States
(12) Patent Application Publication
(10) Pub. No.: US 2025/0325024 A1
(43) Pub. Date: Oct. 23, 2025

(54) ATOMIZER AND ELECTRONIC ATOMIZATION DEVICE

(71) Applicant: SMOORE INTERNATIONAL HOLDINGS LIMITED, George Town (KY)

(72) Inventors: Jianguo WANG, Manassas, VA (US); Yueyang ZHAO, Shenzhen (CN); Ying ZHANG, Shenzhen (CN); Dayue JIANG, Shenzhen (CN); Jinfeng JIANG, Shenzhen (CN); Xiaobin WANG, Shenzhen (CN); Rongji HUANG, Shenzhen (CN)

(21) Appl. No.: 19/254,525

(22) Filed: Jun. 30, 2025

Related U.S. Application Data
(63) Continuation of application No. PCT/CN2023/136894, filed on Dec. 6, 2023.

(30) Foreign Application Priority Data
Dec. 30, 2022 (CN) 202211743753.2

(51) Int. Cl. A24F 40/30; A24B 15/32; A24F 40/10; A24F 40/44; A24F 40/46; A24F 40/485; A24F 40/51; H05B 3/22

(52) U.S. Cl. CPC A24F 40/30; A24B 15/32; A24F 40/10; A24F 40/44; A24F 40/46; A24F 40/485; A24F 40/51; H05B 3/22

(57) ABSTRACT

An atomizer includes: a plurality of liquid storage chambers, media to be atomized being stored in the plurality of liquid storage chambers, and different media to be atomized being stored in at least some liquid storage chambers of the plurality of liquid storage chambers; and a heating assembly including a substrate, the substrate having a liquid absorbing surface and an atomization surface that are oppositely arranged, the substrate having a plurality of liquid guide holes for guiding the media to be atomized from the liquid absorbing surface to the atomization surface. The atomization surface has a plurality of atomization regions, and the plurality of liquid storage chambers and the plurality of atomization regions are arranged in a one-to-one correspondence manner. The heating assembly includes a heating element arranged on the atomization surface, or at least a part of the substrate has an electrically-conductive heating capability.

### CROSS-REFERENCE TO PRIOR APPLICATION

This application is a continuation of International Patent Application No. PCT/CN2023/136894, filed on Dec. 6, 2023, which claims priority to Chinese Patent Application No. 202211743753.2, filed on Dec. 30, 2022. The entire disclosure of both applications is hereby incorporated by reference herein.

### FIELD

The present application relates to the technical field of atomization, and in particular to an atomizer and an electronic atomization device.

### BACKGROUND

An electronic atomization device includes a liquid storage chamber and a heating assembly. The liquid storage chamber stores flavored liquid. The heating assembly is in liquid communication with the liquid storage chamber. The heating assembly is used for atomizing the flavored liquid. As a core component of the electronic atomization device, the heating assembly determines an atomization effect and use experience of the electronic atomization device.

The flavored liquid is a mixture, and usually includes solvents and additives. The additives commonly include propylene glycol, glycerol, nicotine salt, fragrances, a flavor additive, a plant extract, and the like. Volatilization characteristics of various components of the flavored liquid differ from each other. In an existing electronic atomization apparatus, a heating assembly is used for differentially atomizing the various components, affecting volatilization of some components and affecting the taste.

### SUMMARY

In an embodiment, the present invention provides an atomizer, comprising: a plurality of liquid storage chambers, media to be atomized being stored in the plurality of liquid storage chambers, and different media to be atomized being stored in at least some liquid storage chambers of the plurality of liquid storage chambers; and a heating assembly comprising a substrate, the substrate having a liquid absorbing surface and an atomization surface that are oppositely arranged, the substrate having a plurality of liquid guide holes configured to guide the media to be atomized from the liquid absorbing surface to the atomization surface, wherein the atomization surface comprises a plurality of atomization regions, and the plurality of liquid storage chambers and the plurality of atomization regions are arranged in a one-to-one correspondence manner, wherein the heating assembly comprises a heating element arranged on the atomization surface, or at least a part of the substrate has an electrically-conductive heating capability so as to serve as the heating element, and wherein the heating element configured to heat the plurality of atomization regions to different atomization temperatures.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an electronic atomization device according to an embodiment of the present application;

FIG. 2 is a schematic structural diagram of a first embodiment of an atomizer according to the present application;

FIG. 3 is a schematic structural diagram of a heating assembly of the atomizer shown in FIG. 2;

FIG. 4 is a schematic structural diagram of an implementation of a substrate of the heating assembly shown in FIG. 3;

FIG. 5 is a schematic structural diagram of another implementation of a substrate of the heating assembly shown in FIG. 3;

FIG. 6 is a schematic structural diagram of yet another implementation of a substrate of the heating assembly shown in FIG. 3;

FIG. 7 is a schematic structural diagram of an implementation of a heating element of the heating assembly shown in FIG. 3;

FIG. 8 is a schematic structural diagram of another implementation of a heating element of the heating assembly shown in FIG. 3;

FIG. 9 is a schematic structural diagram of yet another implementation of a heating element of the heating assembly shown in FIG. 3;

FIG. 10 is a schematic structural diagram of still another implementation of a heating element of the heating assembly shown in FIG. 3;

FIG. 11 is a schematic structural diagram of a second embodiment of an atomizer according to the present application;

FIG. 12 is a schematic structural diagram of a heating assembly of the atomizer shown in FIG. 11;

FIG. 13 is a schematic structural diagram of an implementation of a substrate of the heating assembly shown in FIG. 12;

FIG. 14 is a schematic structural diagram of another implementation of a substrate of the heating assembly shown in FIG. 12;

FIG. 15 is a schematic structural diagram of an implementation of a heating element of the heating assembly shown in FIG. 12;

FIG. 16 is a schematic structural diagram of another implementation of a heating element of the heating assembly shown in FIG. 12;

FIG. 17 is a schematic structural diagram of yet another implementation of a heating element of the heating assembly shown in FIG. 12;

FIG. 18 is a schematic structural diagram of still another implementation of a heating element of the heating assembly shown in FIG. 12;

FIG. 19 is a schematic diagram of a partial structure of a heating assembly of a third embodiment of an atomizer according to the present application;

FIG. 20 is a top-view schematic structural diagram of a liquid storage chamber of a fourth embodiment of an atomizer according to the present application;

FIG. 21 is a schematic structural diagram of an implementation of a heating element of a heating assembly according to the present application;

FIG. 22 is a schematic flowchart of a control method for heating atomization according to an embodiment of the present application;

FIG. 23 is a schematic flowchart of an implementation of S02 of the control method for heating atomization provided in FIG. 22;

FIG. 24 is a schematic flowchart of another implementation of S02 of the control method for heating atomization provided in FIG. 22;

FIG. 25 is a schematic flowchart of yet another implementation of S02 of the control method for heating atomization provided in FIG. 22;

FIG. 26 is a schematic flowchart of still another implementation of S02 of the control method for heating atomization provided in FIG. 22;

FIG. 27 is a schematic block diagram of a computer-readable storage medium according to an embodiment of the present application;

FIG. 28 is a schematic structural diagram of a liquid storage chamber according to specific embodiment 1 of the present disclosure;

FIG. 29 is a schematic structural diagram of a substrate of a heating assembly according to specific embodiment 1 of the present application;

FIG. 30 is a schematic structural diagram after a liquid storage chamber and a substrate of a heating assembly are assembled according to specific embodiment 1 of the present application;

FIG. 31 is a schematic structural diagram of a liquid storage chamber according to specific embodiment 2 of the present disclosure;

FIG. 32 is a schematic structural diagram of a substrate of a heating assembly according to specific embodiment 2 of the present application; and

FIG. 33 is a schematic structural diagram after a liquid storage chamber and a substrate of a heating assembly are assembled according to specific embodiment 2 of the present application.

### DETAILED DESCRIPTION

In an embodiment, the present invention provides an atomizer and an electronic atomization device, so as to effectively atomize different components in flavored liquid and improve tastes.

In an embodiment, the present invention provides an atomizer. The atomizer includes a plurality of liquid storage chambers and a heating assembly. Media to be atomized are stored in the liquid storage chambers, and different media to be atomized are stored in at least some of the plurality of liquid storage chambers. The heating assembly includes a substrate; the substrate has a liquid absorbing surface and an atomization surface that are oppositely arranged; the substrate has a plurality of liquid guide holes, and the liquid guide holes are used for guiding the media to be atomized from the liquid absorbing surface to the atomization surface; and the atomization surface includes a plurality of atomization regions, and the plurality of liquid storage chambers and the plurality of atomization regions are arranged in a one-to-one correspondence manner. The heating assembly further includes a heating element, the heating element is arranged on the atomization surface, or at least a part of the substrate has an electrically-conductive heating capability, to serve as the heating element. The heating element is used for heating the plurality of atomization regions to different atomization temperatures.

In an implementation, the atomizer includes two liquid storage chambers, which are a first liquid storage chamber and a second liquid storage chamber, where a first medium to be atomized is stored in the first liquid storage chamber, and a second medium to be atomized is stored in the second liquid storage chamber; a boiling point of the first medium to be atomized is lower than a boiling point of the second medium to be atomized;
the substrate includes a first sub-substrate and a second sub-substrate that are connected to each other, the first sub-substrate has a first atomization region, and the second sub-substrate has a second atomization region; the first liquid storage chamber is arranged corresponding to the first atomization region, and the second liquid storage chamber is arranged corresponding to the second atomization region;
the heating element is used for heating the first atomization region to a first atomization temperature, and heating the second atomization region to a second atomization temperature, and the first atomization temperature is lower than the second atomization temperature; and the first atomization temperature is an average temperature of the first atomization region, and the second atomization temperature is an average temperature of the second atomization region.

In an implementation, the boiling point of the first medium to be atomized ranges from 20° C. to 250° C., and the boiling point of the second medium to be atomized ranges from 250° C. to 360° C.; the first sub-substrate has a plurality of first liquid guide holes, and the second sub-substrate has a plurality of second liquid guide holes; the diameter of the first liquid guide holes is greater than or equal to 20 μm, and the diameter of the second liquid guide holes is less than or equal to 30 μm; and the first sub-substrate and the second sub-substrate satisfy one or more of the following conditions (1) to (4):
(1) the diameter of the first liquid guide holes is greater than the diameter of the second liquid guide holes;
(2) a ratio of the thickness of the first sub-substrate to the diameter of the first liquid guide holes is less than a ratio of the thickness of the second sub-substrate to the diameter of the second liquid guide holes;
(3) the length of the first liquid guide holes is less than the length of the second sub-substrate; and
(4) the porosity of the first sub-substrate is greater than the porosity of the second sub-substrate.

In an implementation, the first medium to be atomized includes propylene glycol, glycerol, and a low-boiling-point aroma substance; the second medium to be atomized includes propylene glycol, glycerol, and a high-boiling-point aroma substance; contents of the propylene glycol and the glycerol in the first medium to be atomized are different from the contents of the propylene glycol and the glycerol in the second medium to be atomized;
the diameter of the first liquid guide holes is greater than or equal to 30 μm, and the diameter of the second liquid guide holes is less than or equal to 20 μm; and the ratio of the thickness of the first sub-substrate to the diameter of the first liquid guide holes is less than 10:1, and the ratio of the thickness of the second sub-substrate to the diameter of the second liquid guide holes is greater than 10:1. In an implementation, the content of the propylene glycol in the first medium to be atomized is greater than the content of the glycerol; the content of the propylene glycol in the second medium to be atomized is less than the content of the glycerol; and the low-boiling-point aroma substance includes nicotine or nicotine salt, and the high-boiling-point aroma substance comprises a plant extract.

In an implementation, the boiling point of the first medium to be atomized ranges from 20° C. to 250° C.; the boiling point of the second medium to be atomized ranges from 400° C. to 600° C.; the first sub-substrate has a plurality of first liquid guide holes, and the second sub-substrate has a plurality of second liquid guide holes; the diameter of the first liquid guide holes is greater than or equal to 20 μm, and the diameter of the second liquid guide holes is greater than or equal to 20 μm; and the diameter of the second liquid guide holes is greater than the diameter of the first liquid guide holes; or
the boiling point of the first medium to be atomized ranges from 250° C. to 360° C.; and the boiling point of the second medium to be atomized ranges from 400° C. to 600° C.; the first sub-substrate has a plurality of first liquid guide holes, and the second sub-substrate has a plurality of second liquid guide holes; the diameter of the first liquid guide holes is less than or equal to 20 μm, and the diameter of the second liquid guide holes is greater than or equal to 20 μm; and the diameter of the second liquid guide holes is greater than the diameter of the first liquid guide holes.

In an implementation, the boiling point of the first medium to be atomized ranges from 20° C. to 250° C.; the first medium to be atomized comprises propylene glycol, glycerol, and a low-boiling-point aroma substance, and the second medium to be atomized comprises a sweetening agent; or
the boiling point of the first medium to be atomized ranges from 250° C. to 360° C.; and the first medium to be atomized comprises propylene glycol, glycerol, and a high-boiling-point aroma substance, and the second medium to be atomized comprises a sweetening agent.

In an implementation, the atomizer includes three liquid storage chambers, which are a first liquid storage chamber, a second liquid storage chamber, and a third liquid storage chamber, where a first medium to be atomized is stored in the first liquid storage chamber, a second medium to be atomized is stored in the second liquid storage chamber, and a third medium to be atomized is stored in the third liquid storage chamber; a boiling point of the first medium to be atomized is lower than a boiling point of the second medium to be atomized, and the boiling point of the second medium to be atomized is lower than a boiling point of the third medium to be atomized;
the substrate includes a first sub-substrate, a second sub-substrate, and a third sub-substrate that are connected to each other, the first sub-substrate has a first atomization region, the second sub-substrate has a second atomization region, and the third sub-substrate has a third atomization region; the first liquid storage chamber is arranged corresponding to the first atomization region, the second liquid storage chamber is arranged corresponding to the second atomization region, and the third liquid storage chamber is arranged corresponding to the third atomization region;
the heating element is used for heating the first atomization region to a first atomization temperature, heating the second atomization region to a second atomization temperature, and heating the third atomization region to a third atomization temperature; the first atomization temperature is lower than the second atomization temperature, and the second atomization temperature is lower than the third atomization temperature; and the first atomization temperature is an average temperature of the first atomization region, the second atomization temperature is an average temperature of the second atomization region, the third atomization temperature is an average temperature of the third atomization region.

In an implementation, the boiling point of the first medium to be atomized ranges from 20° C. to 250° C., the boiling point of the second medium to be atomized ranges from 250° C. to 360° C., and the boiling point of the third medium to be atomized ranges from 400° C. to 600° C.;
the first sub-substrate has a plurality of first liquid guide holes, the second sub-substrate has a plurality of second liquid guide holes, and the third sub-substrate has a plurality of third liquid guide holes; the diameter of the first liquid guide holes is greater than or equal to 20 μm, the diameter of the second liquid guide holes is less than or equal to 30 μm, and the diameter of the third liquid guide holes is greater than 20 μm; the diameter of the third liquid guide holes is greater than both the diameter of the first liquid guide holes and the diameter of the second liquid guide holes; and the first sub-substrate and the second sub-substrate satisfy one or more of the following conditions (1) to (4):
(1) the diameter of the first liquid guide holes is greater than the diameter of the second liquid guide holes;
(2) a ratio of the thickness of the first sub-substrate to the diameter of the first liquid guide holes is less than a ratio of the thickness of the second sub-substrate to the diameter of the second liquid guide holes;
(3) the length of the first liquid guide holes is less than the length of the second sub-substrate; and
(4) the porosity of the first sub-substrate is greater than the porosity of the second sub-substrate.

In an implementation, the first medium to be atomized includes propylene glycol, glycerol, and a low-boiling-point aroma substance; the second medium to be atomized includes propylene glycol, glycerol, and a high-boiling-point aroma substance, and the third medium to be atomized comprises a sweetening agent; contents of the propylene glycol and the glycerol in the first medium to be atomized are different from the contents of the propylene glycol and the glycerol in the second medium to be atomized;
the diameter of the first liquid guide holes is greater than or equal to 30 μm, the diameter of the second liquid guide holes is less than or equal to 20 μm, and the diameter of the third liquid guide holes is greater than 30 μm; and a ratio of the thickness of the first sub-substrate to the diameter of the first liquid guide holes is less than 10:1, a ratio of the thickness of the second sub-substrate to the diameter of the second liquid guide holes is greater than 10:1, and a ratio of the thickness of the third sub-substrate to the diameter of the third liquid guide holes is less than 8:1.

In an implementation, the first sub-substrate, the second sub-substrate and the third sub-substrate are all dense substrates, and the first liquid guide holes, the second liquid guide holes and the third liquid guide holes are all through holes penetrating the liquid absorbing surface and the atomization surface; or
some of the first sub-substrate, the second sub-substrate and the third sub-substrate are dense substrates, and the other part are cellular substrates; and the liquid guide holes in the dense substrates are through holes penetrating the liquid absorbing surface and the atomization surface, and the liquid guide holes in the cellular substrates are disordered holes of the cellular substrates.

In an implementation, the heating element is arranged merely in the second atomization region; or
the heating element includes a heating portion and a heat conduction portion that are connected to each other, and the heating portion is arranged merely in the second atomization region, and the heat conduction portion is at least partially arranged in the first atomization region; or
the heating element includes a first heating portion and a second heating portion that are connected to each other, the first heating portion is arranged in the first atomization region, and the second heating portion is arranged in the second atomization region; and the resistance of the first heating portion is different from the resistance of the second heating portion, and/or a heat conductivity coefficient of material of the first heating portion is different from a heat conductivity coefficient of material of the second heating portion; or
the heating element includes a first heating sub-element and a second heating sub-element that are independent of each other, the first heating sub-element is arranged in the first atomization region, and the second heating sub-element is arranged in the second atomization region.

In an implementation, the first atomization region and the third atomization region are located on two opposite sides of the second atomization region respectively; and the heating element is arranged merely in the second atomization region; or
the heating element includes a heating portion and a heat conduction portion that are connected to each other, and the heating portion is arranged merely in the second atomization region, and the heat conduction portion is at least partially arranged in the first atomization region and/or the third atomization region; or
the heating element includes a first heating sub-portion, a second heating sub-portion, and a third heating sub-portion that are connected to each other, the first heating sub-portion is arranged in the first atomization region, the second heating sub-portion is arranged in the second atomization region, the third heating sub-portion is arranged in the third atomization region, the first heating sub-portion, the second heating sub-portion, and the third heating sub-portion have different resistances, or a heat conductivity coefficient of material of the first heating sub-portion, a heat conductivity coefficient of material of the second heating sub-portion, and a heat conductivity coefficient of material of the third heating sub-portion are different; or
the heating element includes a first heating sub-element, a second heating sub-element, and a third heating sub-element that are independent of each other, the first heating sub-element is arranged in the first atomization region, the second heating sub-element is arranged in the second atomization region, and the third heating sub-element is arranged in the third atomization region.

In an implementation, the substrate is a dense substrate, and the plurality of the liquid guide holes are arranged in an array;
the heating element includes a plurality of micro heating components, and the plurality of micro heating components are arranged in an array; each micro heating component is arranged around at least one liquid guide hole; and the micro heating components in each row and/or column are independent of each other.

In an implementation, the atomizer further includes a plurality of sensors, where the sensors are arranged on the substrate, and the plurality of sensors and the plurality of atomization regions are arranged in a one-to-one correspondence manner.

In an implementation, the substrate is made of dense material, the liquid guide holes are through holes penetrating the liquid absorbing surface and the atomization surface, and the sensors are arranged on the walls of the liquid guide holes.

In an implementation, the plurality of the atomization regions are arranged in parallel or in a ring.

To resolve the foregoing technical problems, a second technical solution provided in the present application is as follows. An electronic atomization device is provided. The electronic atomization device includes: an atomizer and a main unit, where the atomizer is the atomizer of any one of the above items; and the main unit is used for providing electric energy for a heating assembly of the atomizer to work and controlling the heating assembly of the atomizer to atomize a medium to be atomized.

The present application has the following beneficial effects: Different from the prior art, an atomizer and an electronic atomization device are disclosed in the present application. The atomizer includes a plurality of liquid storage chambers and a heating assembly. Media to be atomized are stored in the liquid storage chambers, and different media to be atomized are stored in at least some of the plurality of liquid storage chambers. The heating assembly includes a substrate; the substrate has a liquid absorbing surface and an atomization surface that are oppositely arranged; the substrate has a plurality of liquid guide holes, and the liquid guide holes are used for guiding the media to be atomized from the liquid absorbing surface to the atomization surface; and the atomization surface includes a plurality of atomization regions, and the plurality of liquid storage chambers and the plurality of atomization regions are arranged in a one-to-one correspondence manner. The heating assembly further includes a heating element, the heating element is arranged on the atomization surface, or at least a part of the substrate has an electrically-conductive heating capability, to serve as the heating element. The heating element is used for heating the plurality of atomization regions to different atomization temperatures. Through the above arrangement, different atomization regions have different atomization temperatures, such that specific atomization is performed on different media to be atomized in different liquid storage chambers, volatilization of components of a media to be atomized in each liquid storage chamber is guaranteed, and a taste is improved.

The technical solutions in embodiments of the present application are clearly and completely described in the following with reference to the accompanying drawings in the embodiments of the present application. Apparently, the described embodiments are merely some rather than all of the embodiments of the present application. All other embodiments obtained by a person of ordinary skill in the art based on the embodiments of the present application without creative efforts shall fall within the protection scope of the present application.

In the following description, for the purpose of illustration rather than limitation, specific details such as the specific system structure, interface, and technology are proposed to thoroughly understand the present application.

The terms “first”, “second”, and “third” in the present application are merely intended for a purpose of description, and shall not be understood as indicating or implying of relative importance or implicitly indicating the number of indicated technical features. Therefore, features defining “first”, “second”, and “third” can explicitly or implicitly include at least one of the features. In description of this application, “a plurality of” means at least two, such as two and three unless it is specifically defined otherwise. All directional indications (for example, upper, lower, left, right, front, and back) in the embodiments of the present application are only used for explaining relative position relationships, movement situations, or the like between the various components in a specific posture (as shown in the accompanying drawings). If the specific posture changes, the directional indications change accordingly. In the embodiments of the present application, the terms “include”, “have”, and their any variations are intended to cover non-exclusive encompassing. For example, a process, method, system, product, or apparatus that includes a series of steps or units is not limited to the listed steps or units, but further optionally includes a step or unit that is not listed, or further optionally includes another step or component that is intrinsic to the process, method, product, or apparatus.

Embodiment mentioned in the specification means that particular features, structures, or characteristics described with reference to the embodiment may be included in at least one embodiment of this application. The term appearing at different positions of this specification may not refer to the same embodiment or an independent or alternative embodiment that is mutually exclusive with another embodiment. A person skilled in the art explicitly or implicitly understands that the embodiments described in the specification may be combined with other embodiments.

The following describes the present application in detail with reference to the accompanying drawings and embodiments.

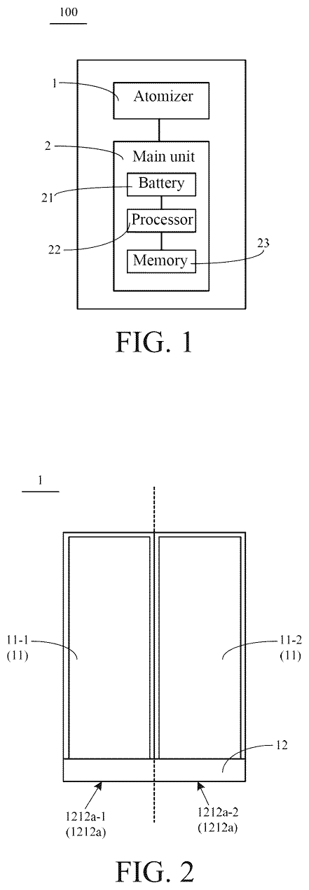

With reference to FIG. 1, FIG. 1 is a schematic structural diagram of an electronic atomization device according to an embodiment of the present application.

In the embodiment, an electronic atomization device 100 is provided. The electronic atomization device 100 may be used for atomizing a medium to be atomized. The electronic atomization device 100 includes an atomizer 1 and a main unit 2 that are electrically connected to each other.

The atomizer 1 is used for storing a medium to be atomized and atomizing the medium to be atomized to form an aerosol capable of being inhaled by a user. The atomizer 1 specifically may be applied to different fields such as medical care, cosmetology, and recreation inhalation. In a specific embodiment, the atomizer 1 may be applied to an electronic aerosol atomization device to atomize a medium to be atomized and generate an aerosol for inhalation by an inhaler. The following embodiments are described by using the recreation inhalation as an example.

Reference may be made to a specific structure and functions of the atomizer 1 involved in the following embodiments for a specific structure and functions of the atomizer 1, same or similar technical effects may also be implemented, and details are not described herein again.

The main unit 2 includes a battery 21 and a processor 22. The battery 21 is used for supplying electric energy to operation of the atomizer 1, to cause the atomizer 1 to atomize the medium to be atomized to form an aerosol. The processor 22 is used for controlling the atomizer 1 to operate, that is, controlling the atomizer 1 to atomize the medium to be atomized. The main unit 2 further includes other components such as a battery holder and an airflow sensor.

The atomizer 1 and the main unit 2 may be integrally arranged or may be detachably connected to each other, which may be designed according to a specific requirement.

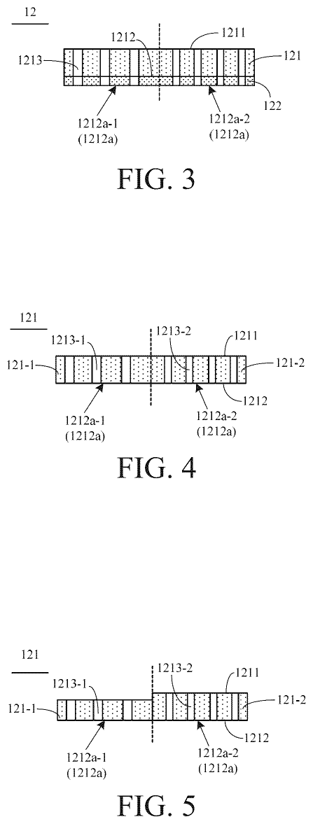

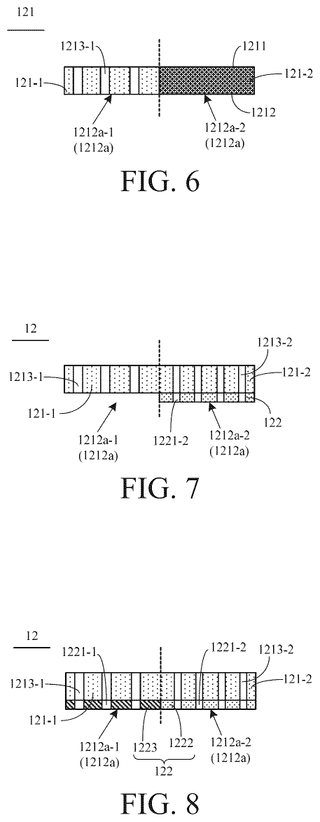

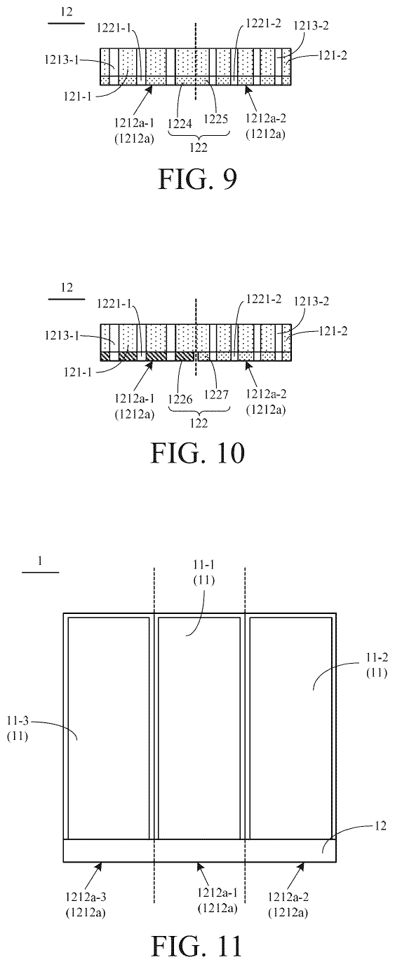

With reference to FIG. 2 to FIG. 10, FIG. 2 is a schematic structural diagram of a first embodiment of an atomizer according to the present application. FIG. 3 is a schematic structural diagram of a heating assembly of the atomizer shown in FIG. 2. FIG. 4 is a schematic structural diagram of an implementation of a substrate of the heating assembly shown in FIG. 3. FIG. 5 is a schematic structural diagram of another implementation of a substrate of the heating assembly shown in FIG. 3. FIG. 6 is a schematic structural diagram of yet another implementation of a substrate of the heating assembly shown in FIG. 3. FIG. 7 is a schematic structural diagram of an implementation of a heating element of the heating assembly shown in FIG. 3. FIG. 8 is a schematic structural diagram of another implementation of a heating element of the heating assembly shown in FIG. 3. FIG. 9 is a schematic structural diagram of yet another implementation of a heating element of the heating assembly shown in FIG. 3. FIG. 10 is a schematic structural diagram of still another implementation of a heating element of the heating assembly shown in FIG. 3.

An atomizer 1 includes a plurality of liquid storage chambers 11 and a heating assembly 12. Media to be atomized are stored in the liquid storage chambers 11. Different media to be atomized are stored in at least some of the plurality of liquid storage chambers 11. That is, the media to be atomized stored in all the liquid storage chambers 11 may be different, or the media to be atomized stored in some liquid storage chambers 11 are different, and the media to be atomized stored in other liquid storage chambers 11 are identical. The heating assembly 12 includes a substrate 121. The substrate 121 has a liquid absorbing surface 1211 and an atomization surface 1212 that are oppositely arranged. The substrate 121 further has a plurality of liquid guide holes 1213. The liquid guide holes 1213 are used for guiding the medium to be atomized from the liquid absorbing surface 1211 to the atomization surface 1212. The atomization surface 1212 includes a plurality of atomization regions 1212a. The plurality of atomization regions 1212a and the plurality of liquid storage chambers 11 are arranged in a one-to-one correspondence manner. That is, one atomization region 1212a is arranged corresponding to one liquid storage chamber 11. One atomization region 1212a only atomizes a medium to be atomized in one liquid storage chamber 11. The heating assembly 12 further includes a heating element 122. The heating element 122 is arranged on the atomization surface 1212, or at least a part of the substrate 121 has an electrically-conductive heating capability, to serve as the heating element 122. The heating element 122 is used for heating the plurality of atomization regions 1212a to different atomization temperatures. In the present application, the atomization temperature in a same atomization region 1212a is not equal everywhere. Thus the atomization temperature in the same atomization region 1212a refers to an average temperature in the same atomization region 1212a. The heating element 122 heats the plurality of atomization regions 1212a to different atomization temperatures. Specifically, after heated by the heating element 122, the plurality of atomization regions 1212a have different average temperatures. The heating assembly 12 is electrically connected to the main unit 2, such that the main unit 2 provides electric energy for the heating assembly 12 and controls the heating assembly 12 to atomize the medium to be atomized.

Specifically, the plurality of liquid storage chambers 11 are arranged in the atomizer 1, the atomization surface 1212 includes the plurality of atomization regions 1212a, and the plurality of atomization regions 1212a and the plurality of liquid storage chambers 11 are arranged in a one-to-one correspondence manner. Since different media to be atomized are stored in the plurality of liquid storage chambers 11, one liquid storage chamber 11 provides one medium to be atomized for one atomization region 1212a, and the atomization region 1212a atomizes only this medium to be atomized. The atomization temperatures of different atomization regions 1212a are different, such that the atomization temperature of each atomization region 1212a is designed according to a characteristic of a medium to be atomized corresponding to the atomization region, and it is guaranteed that all the media to be atomized in the plurality of liquid storage chambers 11 can be sufficiently atomized and volatilized; or a same medium to be atomized is stored in some liquid storage chambers 11, but the atomization temperatures of the atomization regions 1212a corresponding to the same medium to be atomized are different, such that the same medium to be atomized from different liquid storage chambers 11 may be atomized at different temperatures to generate aerosols with different flavors.

It should be noted that in the existing technology, flavored liquid atomized by an electronic atomization device is a mixture. Components of the mixture are distributed according to a requirement into the plurality of above media to be atomized, are respectively stored in the plurality of liquid storage chambers 11, and are respectively atomized by using different atomization temperatures. Thus sufficient atomization and volatilization of each medium to be atomized is guaranteed, and a poor taste caused by indiscriminate atomization of various components of the flavored liquid by using a same heating assembly is avoided.

In an implementation, the plurality of liquid storage chambers 11 and the heating assembly 12 form an integrated structure, and are specifically manufactured by using a chip machining technology or a semiconductor machining technology.

In an implementation, the liquid guide holes 1213 in different atomization regions 1212a have different diameters, and/or the liquid guide holes 1213 in different atomization regions 1212a have different lengths, and/or the liquid guide holes 1213 in different atomization regions 1212a have different porosities, to cause the different atomization regions 1212a have different liquid supply speeds. In combination with the different atomization temperatures of the different atomization regions 1212a, it is guaranteed that the plurality of media to be atomized in the plurality of liquid storage chambers 11 are sufficiently atomized.

In an implementation, the diameter of each liquid guide hole 1213 ranges from 2 μm to 100 μm; and/or the porosity of each liquid guide hole 1213 ranges from 10% to 70%. It may be understood that the diameter and/or the porosity of the liquid guide hole 1213 is specifically designed according to a liquid supply requirement of different atomization regions 1212a.

In the embodiment, the atomizer 1 includes two liquid storage chambers 11, which are a first liquid storage chamber 11-1 and a second liquid storage chamber 11-2 respectively. A first medium to be atomized is stored in the first liquid storage chamber 11-1. A second medium to be atomized is stored in the second liquid storage chamber 11-2. A boiling point of the first medium to be atomized is lower than a boiling point of the second medium to be atomized. The substrate 121 includes a first sub-substrate 121-1 and a second sub-substrate 121-2 that are connected to each other. The first sub-substrate 121-1 has a first atomization region 1212a-1. The second sub-substrate 121-2 has a second atomization region 1212a-2. The first atomization region 1212a-1 is arranged corresponding to the first liquid storage chamber 11-1, and is used for atomizing the first medium to be atomized. The second atomization region 1212a-2 is arranged corresponding to the second liquid storage chamber 11-2, and is used for atomizing the second medium to be atomized. The heating assembly 12 includes a heating element 122 arranged on the atomization surface 1212. The heating element 122 is used for heating the first atomization region 1212a-1 to a first atomization temperature and heating the second atomization region 1212a-2 to a second atomization temperature. Since the boiling point of the first medium to be atomized in the first atomization region 1212a-1 is lower than the boiling point of the second medium to be atomized in the second atomization region 1212a-2, the first atomization temperature in the first atomization region 1212a-1 is lower than the second atomization temperature in the second atomization region 1212a-2. It should be noted that the heating element 122 and the liquid storage chambers 11 are located at two sides of the substrate 121. The first liquid storage chamber 11-1 and the second liquid storage chamber 11-2 represent same structural meanings as the liquid storage chamber 11, and the first liquid storage chamber 11-1 and the second liquid storage chamber 11-2 are introduced merely for case of description. The first atomization region 1212a-1 and the second atomization region 1212a-2 represent same structural meanings as the atomization region 1212a, and the first atomization region 1212a-1 and the second atomization region 1212a-2 are introduced merely for ease of description.

The first medium to be atomized is a solute system with a plurality of low-boiling-point essences. The first atomization region 1212a-1 corresponding to the first medium to be atomized is mainly used for volatilizing the low-boiling-point essences. The second medium to be atomized is a solute system with a plurality of high-boiling-point essences, and the second atomization region 1212a-2 corresponding to the second medium to be atomized is used for generating an aerosol and volatilizing the high-boiling-point essences.

In an implementation, the boiling point of the first medium to be atomized ranges from 20° C. to 250° C., and the boiling point of the second medium to be atomized ranges from 250° C. to 360° C.

In an implementation, the first medium to be atomized and the second medium to be atomized both include propylene glycol and glycerol. Contents of the propylene glycol and the glycerol in the first medium to be atomized are different from those in the second medium to be atomized. A boiling point of the propylene glycol is 188° C., and a boiling point of the glycerol is 290° C.

Optionally, the content of the propylene glycol is greater than the content of the glycerol in the first medium to be atomized. The content of the glycerol is greater than the content of the propylene glycol in the second medium to be atomized.

Optionally, the first medium to be atomized further includes nicotine and nicotine salt, and/or the second medium to be atomized further includes nicotine and nicotine salt. Optionally, the first medium to be atomized further includes a sweetening agent, and/or the second medium to be atomized further includes a sweetening agent.

Optionally, the first medium to be atomized further includes a low-boiling-point essence.

Optionally, the second medium to be atomized further includes high-boiling-point essences and fragrances.

In an implementation, the first sub-substrate 121-1 has a plurality of first liquid guide holes 1213-1, and the second sub-substrate 121-2 has a plurality of second liquid guide holes 1213-2. The first sub-substrate 121-1 and the second sub-substrate 121-2 satisfy one or more of the following conditions (1) to (4):
(1) the diameter of the first liquid guide holes 1213-1 is greater than the diameter of the second liquid guide holes 1213-2;
(2) a ratio of the thickness of the first sub-substrate 121-1 to the diameter of the first liquid guide holes 1213-1 is less than a ratio of the thickness of the second sub-substrate 121-2 to the diameter of the second liquid guide holes 1213-2;
(3) the length of the first liquid guide hole 1213-1 is less than the length of the second sub-substrate 121-2; and
(4) the porosity of the first sub-substrate 121-1 is greater than the porosity of the second sub-substrate 121-2.

For example, the diameter of the first liquid guide holes 1213-1 is greater than the diameter of the second liquid guide holes 1213-2. With the larger diameter, the first liquid guide holes 1213-1 have lower energy density, and therefore have a lower temperature field, to atomize the first medium to be atomized having a lower boiling point. With the smaller diameter, the second liquid guide holes 1213-2 have higher energy density (usually greater than 1 mW/cm²), and therefore have a higher temperature field, to atomize the second medium to be atomized having a higher boiling point. Specifically, in a case where the first sub-substrate 121-1 and the second sub-substrate 121-2 have the same thickness, the first liquid guide holes 1213-1 have a larger diameter and a higher liquid supply speed. Thus a liquid supply amount of the first atomization region 1212a-1 is relatively abundant, and the first atomization temperature of the first atomization region 1212a-1 is lower. The second liquid guide holes 1213-2 have a smaller diameter and a lower liquid supply speed. Thus a liquid supply amount of the second atomization region 1212a-2 is relatively insufficient, and the second atomization temperature of the second atomization region 1212a-2 is lower. Accordingly, the first atomization temperature for atomizing the first medium to be atomized is lower than the second atomization temperature for atomizing the second medium to be atomized. It should be noted that The first liquid guide holes 1213-1 and the second liquid guide holes 1213-2 represent same structural meanings as the liquid guide holes 1213, and the first liquid guide holes 1213-1 and the second liquid guide holes 1213-2 are introduced merely for case of description.

In an implementation, the first sub-substrate 121-1 and the second sub-substrate 121-2 are both made of dense materials, for example, dense ceramics, glass, metal, and silicon. The first liquid guide holes 1213-1 and the second liquid guide holes 1213-2 are both straight-through holes that penetrate the liquid absorbing surface 1211 and the atomization surface 1212. The straight-through holes may be penetrating hole formed by means of laser induction and erosion. The plurality of straight-through holes may be arranged in order (for example, distributed in an array) or distributed in a disordered manner (for example, distributed randomly). The diameter of the first liquid guide holes 1213-1 is greater than the diameter of the second liquid guide holes 1213-2. The diameter of the first liquid guide holes 1213-1 is greater than or equal to 20 μm. In a specific implementation, the diameter of the first liquid guide holes 1213-1 is greater than or equal to 20 μm and less than or equal to 60 μm. In a specific implementation, the diameter of the first liquid guide holes 1213-1 is greater than or equal to 30 μm. The diameter of the second liquid guide holes 1213-2 is less than or equal to 30 μm. In a specific implementation, the diameter of the second liquid guide holes 1213-2 is greater than or equal to 2 μm and less than or equal to 30 μm. In a specific implementation, the diameter of the second liquid guide holes 1213-2 is less than or equal to 20 μm.

And/or, a ratio of the thickness of the first sub-substrate 121-1 to the diameter of the first liquid guide holes 1213-1 is less than a ratio of the thickness of the second sub-substrate 121-2 to the diameter of the second liquid guide holes 1213-2. It may be understood that when power of the heating element 122 is identical, a larger ratio of the thickness of the substrate to the diameter of the liquid guide holes indicates a lower liquid supply speed, slower heat consumption, and a higher atomization temperature of the corresponding atomization region. On the contrary, a smaller ratio of the thickness of the substrate to the diameter of the liquid guide holes indicates a higher liquid supply speed, faster heat consumption, and a lower atomization temperature of the corresponding atomization region. In a specific implementation, a ratio of the thickness of the first sub-substrate 121-1 to the diameter of the first liquid guide holes 1213-1 is less than 10:1. In a specific implementation, a ratio of the thickness of the first sub-substrate 121-1 to the diameter of the first liquid guide holes 1213-1 is less than 5:1. In a specific implementation, a ratio of the thickness of the second sub-substrate 121-2 to the diameter of the second liquid guide holes 1213-2 is greater than 10:1. In a specific implementation, a ratio of the thickness of the second sub-substrate 121-2 to the diameter of the second liquid guide holes 1213-2 is greater than 15:1.

Optionally, the length of the first liquid guide holes 1213-1 is equal to the length of the second liquid guide holes 1213-2 (as shown in FIG. 4). Specifically, the liquid absorbing surface 1211 and the atomization surface 1212 of the substrate 121 are both plane surfaces and parallel to each other, and the thickness of the first sub-substrate 121-1 is equal to the thickness of the second sub-substrate 121-2.

An axis of each first liquid guide hole 1213-1 is parallel to the thickness direction of the first sub-substrate 121-1. In this case, the length of the first liquid guide hole 1213-1 is equal to the thickness of the first sub-substrate 121-1. An axis of each second liquid guide hole 1213-2 is parallel to the thickness direction of the second first sub-substrate 121-2. In this case, the length of the second liquid guide hole 1213-2 is equal to the thickness of the second sub-substrate 121-2. The axis of the first liquid guide hole 1213-1 is parallel to the axis of the second liquid guide hole 1213-2. Since the thickness of the first sub-substrate 121-1 is equal to the thickness of the second sub-substrate 121-2, the length of the first liquid guide hole 1213-1 is equal to the length of the second liquid guide hole 1213-2.

Optionally, the length of the first liquid guide hole 1213-1 is less than the length of the second liquid guide hole 1213-2 (as shown in FIG. 5). Specifically, the atomization surface 1212 of the substrate 121 is a plane surface, the liquid absorbing surface 1211 is a step surface, and the thickness of the first sub-substrate 121-1 is less than the thickness of the second sub-substrate 121-2. The surface of the first sub-substrate 121-1 located on the liquid absorbing surface 1211 and the surface of the first sub-substrate 121-1 located on the atomization surface 1212 are both plane surfaces and parallel to each other. The axis of the first liquid guide hole 1213-1 is parallel to the thickness direction of the first sub-substrate 121-1. In this case, the length of the first liquid guide hole 1213-1 is equal to the thickness of the first sub-substrate 121-1. The surface of the second sub-substrate 121-2 located on the liquid absorbing surface 1211 and the surface of the second sub-substrate 121-2 located on the atomization surface 1212 are both plane surfaces and parallel to each other. The axis of the second liquid guide hole 1213-2 is parallel to the thickness direction of the second sub-substrate 121-2. In this case, the length of the second liquid guide hole 1213-2 is equal to the thickness of the second sub-substrate 121-2. The axis of the first liquid guide hole 1213-1 is parallel to the axis of the second liquid guide hole 1213-2. Since the thickness of the first sub-substrate 121-1 is less than the thickness of the second sub-substrate 121-2, the length of the first liquid guide hole 1213-1 is less than the length of the second liquid guide hole 1213-2. The atomization surface 1212 of the substrate 121 is set to be a plane surface, and the liquid absorbing surface 1211 is a step surface. It is convenient to arrange the heating element 122 on the atomization surface 1212 while the thickness of the first sub-substrate 121-1 is less than the thickness of the second sub-substrate 121-2. The continuous heating element 122 (for example, a heating film) is advantageously deposited on the entire atomization surface 1212 by setting the atomization surface 1212 of the substrate 121 to be a plane surface.

It should be noted that the second liquid guide hole 1213-2 has a smaller diameter and a greater length, such that a liquid supply speed is lower, the second atomization temperature is higher, then aerosol particles generated through atomization are smaller, and these smaller aerosol particles may enter pulmonary alveoli and reach blood through the pulmonary alveoli, thereby increasing satisfaction. The first liquid guide hole 1213-1 has a larger diameter and a less length, such that a liquid supply speed is higher, the first atomization temperature is lower, then aerosol particles generated through atomization are larger. These larger aerosol particles may be deposited in an oral cavity, increasing the tastes. Illustratively, the first medium to be atomized includes a sweetening agent. The second medium to be atomized includes nicotine or a plant extract. By means of a foregoing arrangement manner of the first liquid guide holes 1213-1 and the second liquid guide holes 1213-2, aerosols containing the sweetening agent can be deposited in the oral cavity to increase a sweet taste, and aerosols containing the nicotine or the plant extract can be deposited in the pulmonary alveoli to increase satisfaction and improve user experience.

Optionally, the first sub-substrate 121-1 and the second sub-substrate 121-2 are integrally formed. When the first sub-substrate 121-1 and the second sub-substrate 121-2 have different thicknesses, the thickness of the first sub-substrate 121-1 may be made to be less than the thickness of the second sub-substrate 121-2 in a slotting or thinning manner.

In an implementation, the first sub-substrate 121-1 is made of dense materials, for example, dense ceramics, glass, metal, and silicon. The second sub-substrate 121-2 is made of a cellular material, for example, cellular ceramics. The first sub-substrate 121-1 and the second sub-substrate 121-2 are spliced to form the substrate 121 (as shown in FIG. 6). The plurality of first liquid guide holes 1213-1 on the first sub-substrate 121-1 are through holes penetrating the liquid absorbing surface 1211 and the atomization surface 1212. The diameter of the first liquid guide holes 1213-1 is greater than or equal to 20 μm. In a specific implementation, the diameter of the first liquid guide holes 1213-1 is greater than or equal to 20 μm and less than or equal to 60 μm. In a specific implementation, the diameter of the first liquid guide holes 1213-1 is greater than or equal to 30 μm. The plurality of second liquid guide holes 1213-2 on the second sub-substrate 121-2 are disordered holes of the cellular material. The disordered holes of the cellular material are randomly distributed and extended micro holes formed in a process of preparing the cellular material. The disordered holes of the cellular material are in communication with each other internally, and are different from the straight-through holes arranged on the substrate. Adjacent straight-through holes arranged on the substrate are independent of each other unless the through holes are connected by means of transverse open holes. The diameter of the first liquid guide holes 1213-1 is greater than the diameter of the second liquid guide holes 1213-2. A splicing manner is not limited, and side splicing may be performed; or a mounting hole may be arranged in one of the first sub-substrate 121-1 and the second sub-substrate 121-2, and the other sub-substrate is embedded in the mounting hole.

In an implementation, the heating element 122 is arranged merely in the second atomization region 1212a-2 (as shown in FIG. 7). Heat generated by the heating element 122 is conducted to the first atomization region 1212a-1 by means of heat conduction, to cause the first atomization temperature of the first atomization region 1212a-1 to be lower than the second atomization temperature of the second atomization region 1212a-2. Optionally, the material of the first sub-substrate 121-1 corresponding to the first atomization region 1212a-1 has a higher heat conductivity coefficient. Optionally, the heating element 122 is a heating film. When the second sub-substrate 121-2 is made of dense material, and the second liquid guide holes 1213-2 are through holes penetrating the liquid absorbing surface 1211 and the atomization surface 1212, the heating element 122 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2.

In an implementation, the heating element 122 includes a heating portion 1222 and a heat conduction portion 1223 that are connected to each other. The heating portion 1222 is arranged merely in the second atomization region 1212a-2. The heat conduction portion 1223 is at least partially arranged in the first atomization region 1212a-1 (as shown in FIG. 8). Heat generated by the heating portion 1222 is conducted to the first atomization region 1212a-1 by means of heat conduction of the heat conduction portion 1223, to cause the first atomization temperature of the first atomization region 1212a-1 to be lower than the second atomization temperature of the second atomization region 1212a-2. Optionally, the heating portion 1222 is a heating film, the heat conduction portion 1223 is a heat conduction film, and the heat conduction portion 1223 may be made of insulation material. When the first sub-substrate 121-1 and the second sub-substrate 121-2 are made of dense material, and the first liquid guide holes 1213-1 and the second liquid guide holes 1213-2 are through holes penetrating the liquid absorbing surface 1211 and the atomization surface 1212, the heating portion 1222 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2. The heat conduction portion 1223 has a plurality of first through holes 1221-1. The plurality of first through holes 1221-1 and the plurality of first liquid guide holes 1213-1 are arranged in a one-to-one correspondence manner. An axis of each first through hole 1221-1 coincides with the axis of the first liquid guide hole 1213-1. The heating portion 1222 and the heat conduction portion 1223 may be laterally spliced, or may be partially stacked.

In an implementation, the heating element 122 includes a first heating portion 1224 and a second heating portion 1225 that are connected to each other, that is, the first heating portion 1224 and the second heating portion 1225 are controlled by a same control circuit. The first heating portion 1224 is arranged in the first atomization region 1212a-1, and the second heating portion 1225 is arranged in the second atomization region 1212a-2 (as shown in FIG. 9). The resistance of the first heating portion 1224 is different from the resistance of the second heating portion 1225, and/or a heat conductivity coefficient of material of the first heating portion 1224 is different from a heat conductivity coefficient of the second heating portion 1225, to cause the first atomization temperature of the first atomization region 1212a-1 to be lower than the second atomization temperature of the second atomization region 1212a-2. The shapes or thicknesses of the first heating portion 1224 and the second heating portion 1225, or a resistivity of the material may be designed to make the resistance of the first heating portion 1224 differ from the resistance of the second heating portion 1225. Optionally, the resistance of the second heating portion 1225 is not lower than the resistance of the first heating portion 1224. Optionally, the first heating portion 1224 and the second heating portion 1225 are both heating films. When the first sub-substrate 121-1 and the second sub-substrate 121-2 are made of dense material, and the first liquid guide holes 1213-1 and the second liquid guide holes 1213-2 are through holes penetrating the liquid absorbing surface 1211 and the atomization surface 1212, the first heating portion 1224 has a plurality of first through holes 1221-1. The plurality of first through holes 1221-1 and the plurality of first liquid guide holes 1213-1 are arranged in a one-to-one correspondence manner. An axis of each first through hole 1221-1 coincides with the axis of the first liquid guide hole 1213-1. The second heating portion 1225 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2.

In an implementation, the heating element 122 includes a first heating sub-element 1226 and a second heating sub-element 1227 that are independent of each other, that is, the first heating sub-element 1226 and the second heating sub-element 1227 have control circuits that are independent of each other. The first heating sub-element 1226 is arranged in the first atomization region 1212a-1, and the second heating sub-element 1227 is arranged in the second atomization region 1212a-2 (as shown in FIG. 10). Optionally, the first heating sub-element 1226 and the second heating sub-element 1227 are both heating films. When the first sub-substrate 121-1 and the second sub-substrate 121-2 are made of dense material, and the first liquid guide holes 1213-1 and the second liquid guide holes 1213-2 are through holes penetrating the liquid absorbing surface 1211 and the atomization surface 1212, the first heating sub-element 1226 has a plurality of first through holes 1221-1. The plurality of first through holes 1221-1 and the plurality of first liquid guide holes 1213-1 are arranged in a one-to-one correspondence manner. An axis of each first through hole 1221-1 coincides with the axis of the first liquid guide hole 1213-1. The second heating sub-element 1227 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2.

In an implementation, the heating element 122 has different heat conductivity coefficients or different liquid guide properties corresponding to materials of different atomization regions 1212a.

It should be noted that an example in which the heating element 122 is an element independent of the substrate 121 is used in the foregoing descriptions of the heating element 122. When the substrate 121 at least partially has an electrically-conductive heating capability to serve as the heating element 122, reference may be made to the arrangement manner in which the heating element 122 is an independent element for an arrangement manner of the portion of the substrate 121 having the electrically-conductive heating capability, and details are not described herein again.

In the present application, each effective component in the process of atomization is controllable, particle sizes of the aerosols generated through atomization are controllable, and the aerosols are deposited in organoleptic organs accurately, thus targeted atomization is implemented finally. The controllable components refers to that various essences and fragrances and medicinal components are respectively placed in specific liquid storage chambers 11 as effective materials, and the target organs to be reached by compounds later are taken as targets of atomization. A purpose of the adjustable particle sizes of the aerosols is to make specific effective components into aerosols with specific particle sizes that are controllable, and then deposit the specific effective components at specific organoleptic positions according to a deposit principle of aerosols of the airways respectively. For example, aerosol particles with a particle size of about 10 μm are deposited in the oral cavity and the upper airways. Aerosol particles about 5 μm are deposited in the lower airways. Aerosol particles of 2 μm may enter the pulmonary alveoli. Deposition accurately refers to that in the airways, depending on the particle sizes of the aerosols, the aerosols enter the oral cavity, pass through a throat, a nasal cavity, a trachea, a bronchi, lobes, and the pulmonary alveoli of a human body, and enter a blood circulation system sequentially from large to small and from near to far.

Specifically, in the present application, parameters (including diameter, porosity, length, etc. of the liquid guide holes 1213) corresponding to different atomization regions 1212a of the substrate 121 and energy density are designed to adjust heat flux density and a liquid supply speed, to match the media to be atomized in different liquid storage chambers 11, thus selection and control of the particle sizes and components of the atomized aerosols are implemented, and best atomization experience and atomization efficiency are obtained.

The atomizer 1 further includes a vapor outlet channel, an atomization cavity, and an air inlet channel that are in communication with each other. Aerosols generated by the heating element 122 through atomization are released in the atomization cavity. External air enters through the air inlet channel, carries the aerosols in the atomization cavity to flow out of the vapor outlet channel, and is inhaled by a user. The atomizer 1 further includes structures such as a sealing member and a guide. Reference may be made to the existing technology for arrangement manners of the sealing member, the guide, the vapor outlet channel, the atomization cavity, and the air inlet channel. Corresponding changes may be made according to specific structures of the liquid storage chamber 11 and the heating assembly 12.

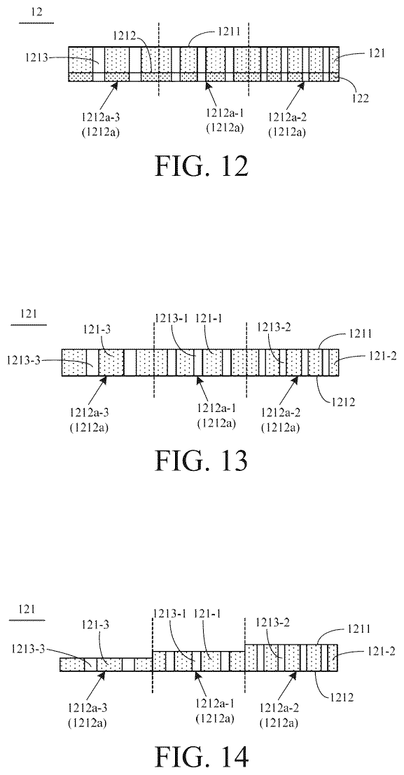

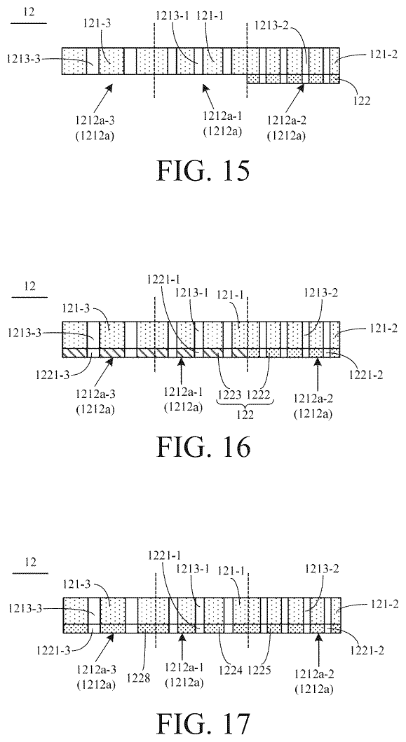

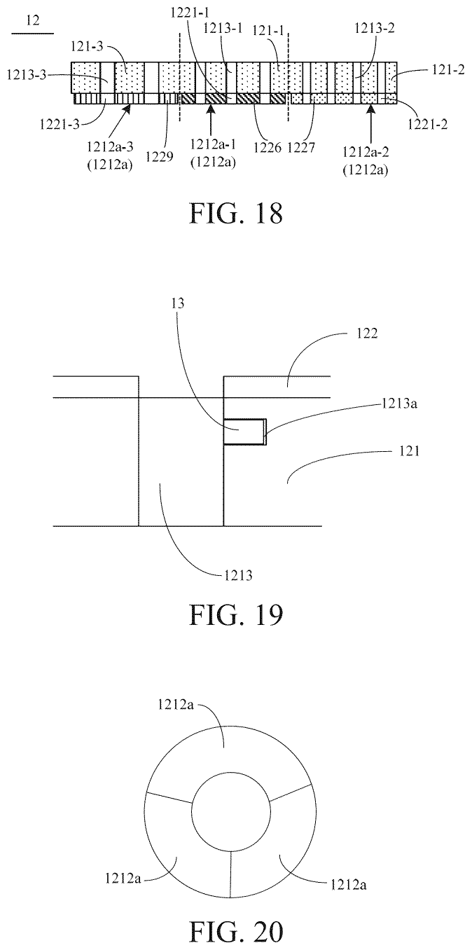

With reference to FIG. 11 to FIG. 18, FIG. 11 is a schematic structural diagram of a second embodiment of an atomizer according to the present application. FIG. 12 is a schematic structural diagram of a heating assembly of the atomizer shown in FIG. 11. FIG. 13 is a schematic structural diagram of an implementation of a substrate of the heating assembly shown in FIG. 12. FIG. 14 is a schematic structural diagram of another implementation of a substrate of the heating assembly shown in FIG. 12. FIG. 15 is a schematic structural diagram of an implementation of a heating element of the heating assembly shown in FIG. 12. FIG. 16 is a schematic structural diagram of another implementation of a heating element of the heating assembly shown in FIG. 12. FIG. 17 is a schematic structural diagram of still another implementation of a heating element of the heating assembly shown in FIG. 12. FIG. 18 is a schematic structural diagram of still another implementation of a heating element of the heating assembly shown in FIG. 12.

A difference between the second embodiment of the atomizer 1 and the first embodiment of the atomizer 1 is as follows: in the second embodiment of the atomizer 1, the atomizer 1 includes three liquid storage chambers 11, and the atomization surface 1212 of the heating assembly 12 includes three atomization regions 1212a; and in the first embodiment of the atomizer 1, the atomizer 1 includes two liquid storage chambers 11, and the atomization surface 1212 of the heating assembly 12 includes two atomization regions 1212a.

In the embodiment, the atomizer 1 includes three liquid storage chambers 11, which are a first liquid storage chamber 11-1, a second liquid storage chamber 11-2, and a third liquid storage chamber 11-3 respectively. A first medium to be atomized is stored in the first liquid storage chamber 11-1. A second medium to be atomized is stored in the second liquid storage chamber 11-2. A third medium to be atomized is stored in the third liquid storage chamber 11-3. A boiling point of the second medium to be atomized is greater than a boiling point of the first medium to be atomized. The boiling point of the third medium to be atomized is greater than a boiling point of the second medium to be atomized. The substrate 121 includes a first sub-substrate 121-1, a second sub-substrate 121-2, and a third sub-substrate 121-3 that are connected to each other. The first sub-substrate 121-1 has a first atomization region 1212a-1. The second sub-substrate 121-2 has a second atomization region 1212a-2. The third sub-substrate 121-3 has a third atomization region 1212a-3. The first atomization region 1212a-1 is arranged corresponding to the first liquid storage chamber 11-1, and is used for atomizing the first medium to be atomized. The second atomization region 1212a-2 is arranged corresponding to the second liquid storage chamber 11-2, and is used for atomizing the second medium to be atomized. The third atomization region 1212a-3 is arranged corresponding to the third liquid storage chamber 11-3, and is used for atomizing the third medium to be atomized. The heating assembly 12 includes a heating element 122 arranged on the atomization surface 1212. The heating element 122 is used for heating the first atomization region 1212a-1 to a first atomization temperature, heating the second atomization region 1212a-2 to a second atomization temperature, and heating the third atomization region 1212a-3 to a third atomization temperature. Since the boiling point of the first medium to be atomized in the first atomization region 1212a-1 is lower than the boiling point of the second medium to be atomized in the second atomization region 1212a-2, the first atomization temperature in the first atomization region 1212a-1 is lower than the second atomization temperature in the second atomization region 1212a-2. The third atomization temperature of the third atomization region 1212a-3 is higher than the second atomization temperature, or the third atomization temperature is lower than the first atomization temperature, or the third atomization temperature is higher than the first atomization temperature and lower than the second atomization temperature.

It should be noted that the heating element 122 and the liquid storage chambers 11 are located at two sides of the substrate 121. The first liquid storage chamber 11-1, the second liquid storage chamber 11-2, and the third liquid storage chamber 11-3 represent same structural meanings as the liquid storage chamber 11, and the first liquid storage chamber 11-1, the second liquid storage chamber 11-2 and the third liquid storage chamber 11-3 are introduced merely for case of description. The first atomization region 1212a-1, the second atomization region 1212a-2, and the third atomization region 1212a-3 represent same structural meanings as the atomization region 1212a, and the first atomization region 1212a-1, the second atomization region 1212a-2, and the third atomization region 1212a-3 are introduced merely for case of description.

The first medium to be atomized is a solute system with a plurality of low-boiling-point essences. The first atomization region 1212a-1 corresponding to the first medium to be atomized is mainly used for volatilizing the low-boiling-point essences. The second medium to be atomized is a solute system with a plurality of high-boiling-point essences, and the second atomization region 1212a-2 corresponding to the second medium to be atomized is used for generating an aerosol and volatilizing the high-boiling-point essences. The third medium to be atomized includes a sweetening agent, and the third atomization region 1212a-3 corresponding to the third medium to be atomized is used for atomizing the sweetening agent.

In an implementation, the boiling point of the first medium to be atomized ranges from 20° C. to 250° C., the boiling point of the second medium to be atomized ranges from 250° C. to 360° C., and the boiling point of the third medium to be atomized (sweetening agent) ranges from 400° C. to 600° C. It should be noted that Since the third medium to be atomized has an extremely high boiling point, the third medium to be atomized only needs to be sprayed out through atomization, that is, taken out along with aerosols generated by atomization of the first medium to be atomized and the second medium to be atomized. Preferably, the third atomization temperature of the third atomization region 1212a-3 is lower than the atomization temperature of the first atomization region 1212a-1. The following describes parameters of the substrate 121 and an arrangement manner of the heating element 122 in detail by using the example.

In an implementation, the first medium to be atomized and the second medium to be atomized both include propylene glycol and glycerol. Contents of the propylene glycol and the glycerol in the first medium to be atomized are different from those in the second medium to be atomized. A boiling point of the propylene glycol is 188° C., and a boiling point of the glycerol is 290° C.

Optionally, the content of the propylene glycol is greater than the content of the glycerol in the first medium to be atomized. The content of the glycerol is greater than the content of the propylene glycol in the second medium to be atomized.

Optionally, the first medium to be atomized further includes nicotine and nicotine salt, and/or the second medium to be atomized further includes nicotine and nicotine salt. Optionally, the first medium to be atomized further includes a low-boiling-point essence.

Optionally, the second medium to be atomized further includes high-boiling-point essences and fragrances.

The first sub-substrate 121-1 has a plurality of first liquid guide holes 1213-1. The second sub-substrate 121-2 has a plurality of second liquid guide holes 1213-2. The third sub-substrate 121-3 has a plurality of third liquid guide holes 1213-3. Reference may be made to the introduction in the first embodiment of the atomizer 1 for the arrangement manners of the first sub-substrate 121-1 and the plurality of first liquid guide holes 1213-1 on the first sub-substrate, and the second sub-substrate 121-2 and the plurality of second liquid guide holes 1213-2 on the second sub-substrate, and details are not described herein again.

In an implementation, the third sub-substrate 121-3 is made of dense materials, for example, dense ceramics, glass, metal, and silicon. The third liquid guide holes 1213-3 are through holes penetrating the liquid absorbing surface 1211 and the atomization surface 1212. In a specific implementation, the diameter of the third liquid guide holes 1213-3 is not less than 20 μm. In a specific implementation, the diameter of the third liquid guide holes 1213-3 is not less than 30 μm.

When the first sub-substrate 121-1, the second sub-substrate 121-2, and the third sub-substrate 121-3 are all made of dense material, the first sub-substrate 121-1, the second sub-substrate 121-2, and the third sub-substrate 121-3 are integrally formed.

Optionally, the diameter of the third liquid guide holes 1213-3 is greater than the diameter of the first liquid guide holes 1213-1.

Optionally, the length of the first liquid guide holes 1213-1, the length of the second liquid guide holes 1213-2, and the length of the third liquid guide holes 1213-3 are equal (as shown in FIG. 13). Specifically, the liquid absorbing surface 1211 and the atomization surface 1212 of the substrate 121 are both plane surfaces and parallel to each other, and the thickness of the first sub-substrate 121-1, the thickness of the second sub-substrate 121-2, and the thickness of the third sub-substrate 121-3 are equal. An axis of each first liquid guide hole 1213-1 is parallel to the thickness direction of the first sub-substrate 121-1. In this case, the length of the first liquid guide hole 1213-1 is equal to the thickness of the first sub-substrate 121-1. An axis of each second liquid guide hole 1213-2 is parallel to the thickness direction of the second first sub-substrate 121-2. In this case, the length of the second liquid guide hole 1213-2 is equal to the thickness of the second sub-substrate 121-2. An axis of each third liquid guide hole 1213-3 is parallel to the thickness direction of the third first sub-substrate 121-3. In this case, the length of the third liquid guide hole 1213-3 is equal to the thickness of the third sub-substrate 121-3. The axis of the first liquid guide hole 1213-1 and the axis of the second liquid guide hole 1213-2 are parallel to the axis of the third liquid guide hole 1213-3. Since the thickness of the first sub-substrate 121-1, the thickness of the second sub-substrate 121-2, and the thickness of the third sub-substrate 121-3 are equal, the length of the first liquid guide hole 1213-1, the length of the second liquid guide hole 1213-2, and the length of the third liquid guide hole 1213-3 are equal.

Optionally, the diameter of the first liquid guide hole 1213-1 is greater than the diameter of the second liquid guide hole 1213-2, and the diameter of the third liquid guide hole 1213-3 is greater than the diameter of the first liquid guide hole 1213-1. The length of the first liquid guide hole 1213-1 is less than the length of the second liquid guide hole 1213-2, and the length of the third liquid guide hole 1213-3 is less than the length of the first liquid guide hole 1213-1 (as shown in FIG. 14). Specifically, the atomization surface 1212 of the substrate 121 is a plane surface, the liquid absorbing surface 1211 is a step surface, the thickness of the first sub-substrate 121-1 is less than the thickness of the second sub-substrate 121-2, and the thickness of the third sub-substrate 121-3 is less than the thickness of the first sub-substrate 121-1.

The surface of the first sub-substrate 121-1 located on the liquid absorbing surface 1211 and the surface of the first sub-substrate 121-1 located on the atomization surface 1212 are both plane surfaces and parallel to each other. The axis of the first liquid guide hole 1213-1 is parallel to the thickness direction of the first sub-substrate 121-1. In this case, the length of the first liquid guide hole 1213-1 is equal to the thickness of the first sub-substrate 121-1. The surface of the second sub-substrate 121-2 located on the liquid absorbing surface 1211 and the surface of the second sub-substrate 121-2 located on the atomization surface 1212 are both plane surfaces and parallel to each other. The axis of the second liquid guide hole 1213-2 is parallel to the thickness direction of the second sub-substrate 121-2. In this case, the length of the second liquid guide hole 1213-2 is equal to the thickness of the second sub-substrate 121-2. The surface of the third sub-substrate 121-3 located on the liquid absorbing surface 1211 and the surface of the third sub-substrate 121-3 located on the atomization surface 1212 are both plane surfaces and parallel to each other. The axis of the third liquid guide hole 1213-3 is parallel to the thickness direction of the third sub-substrate 121-3. In this case, the length of the third liquid guide hole 1213-3 is equal to the thickness of the third sub-substrate 121-3. The axis of the first liquid guide hole 1213-1 and the axis of the second liquid guide hole 1213-2 are parallel to the axis of the third liquid guide hole 1213-3. Since the thickness of the first sub-substrate 121-1 is less than the thickness of the second sub-substrate 121-2, and the thickness of the third sub-substrate 121-3 is less than the thickness of the first sub-substrate 121-1, the length of the first liquid guide hole 1213-1 is less than the length of the second liquid guide hole 1213-2, and the length of the third liquid guide hole 1213-3 is less than the length of the first liquid guide hole 1213-1. The atomization surface 1212 of the substrate 121 is set to be a plane surface, and the liquid absorbing surface 1211 is a step surface. It is convenient to arrange the heating element 122 on the atomization surface 1212 while the length of the first liquid guide hole 1213-1 is less than the length of the second liquid guide hole 1213-2, and the length of the third liquid guide hole 1213-3 is less than the length of the first liquid guide hole 1213-1.

It should be noted that in the first liquid guide hole 1213-1, the second liquid guide hole 1213-2, and the third liquid guide hole 1213-3, the second liquid guide hole 1213-2 has a smaller diameter and a greater length, a liquid supply speed is lower, the second atomization temperature is higher, then aerosol particles generated through atomization are smaller, and these smaller aerosol particles may enter pulmonary alveoli and reach blood through the pulmonary alveoli, thereby increasing satisfaction. The third liquid guide hole 1213-3 has a larger diameter and a less length, a liquid supply speed is higher, the third atomization temperature is lower, then aerosol particles generated through atomization are larger. These larger aerosol particles may be deposited in an oral cavity, increasing the tastes. Illustratively, the third medium to be atomized includes a sweetening agent. The second medium to be atomized includes nicotine or a plant extract. By means of a foregoing arrangement manner of the first liquid guide holes 1213-1, the second liquid guide holes 1213-2 and the third liquid guide holes 1213-3, aerosols containing the sweetening agent can be deposited in the oral cavity to increase a sweet taste, and aerosols containing the nicotine or the plant extract can be deposited in the pulmonary alveoli to increase satisfaction and improve user experience.

In an implementation, the third sub-substrate 121-3 is made of a cellular material, for example, cellular ceramics. The first sub-substrate 121-1, the second sub-substrate 121-2, and the third sub-substrate 121-3 are spliced into the substrate 121. The plurality of third liquid guide holes 1213-3 on the third sub-substrate 121-3 are disordered holes of the cellular material.

In an implementation, the heating element 122 is arranged merely in the second atomization region 1212a-2 (as shown in FIG. 15). Heat generated by the heating element 122 is conducted to the first atomization region 1212a-1 and the third atomization region 1212a-3 through heat conduction, to cause the first atomization temperature of the first atomization region 1212a-1 to be lower than the second atomization temperature of the second atomization region 1212a-2, and the third atomization temperature of the third atomization region 1212a-3 to be lower than the first atomization temperature of the first atomization region 1212a-1. Optionally, the material of the first sub-substrate 121-1 corresponding to the first atomization region 1212a-1 and the material of the third sub-substrate 121-3 corresponding to the third atomization region 1212a-3 have higher heat conductivity coefficients. Optionally, the heating element 122 is a heating film. When the second sub-substrate 121-2 is made of dense material, and the second liquid guide holes 1213-2 are through holes penetrating the liquid absorbing surface 1211 and the atomization surface 1212, the heating element 122 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2.

In an implementation, the heating element 122 includes a heating portion 1222 and a heat conduction portion 1223 that are connected to each other. The heating portion 1222 is arranged merely in the second atomization region 1212a-2. The heat conduction portion 1223 is at least partially arranged in the first atomization region 1212a-1 and the third atomization region 1212a-3 (as shown in FIG. 16). Heat generated by the heating portion 1222 is conducted to the first atomization region 1212a-1 and the third atomization region 1212a-3 through heat conduction of the heat conduction portion 1223, to cause the first atomization temperature of the first atomization region 1212a-1 to be lower than the second atomization temperature of the second atomization region 1212a-2, and the third atomization temperature of the third atomization region 1212a-3 to be lower than the first atomization temperature of the first atomization region 1212a-1. Optionally, the heating portion 1222 is a heating film, and the heat conduction portion 1223 is a heat conduction film. When the first sub-substrate 121-1, the second sub-substrate 121-2, and the third sub-substrate 121-3 are made of dense material, and the first liquid guide holes 1213-1, the second liquid guide holes 1213-2, and the third liquid guide holes 1213-3 are through holes penetrating the liquid absorbing surface 1211 and the atomization surface 1212, the heating portion 1222 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2. The heat conduction portion 1223 has a plurality of first through holes 1221-1 and a plurality of third through holes 1221-3. The plurality of first through holes 1221-1 and the plurality of first liquid guide holes 1213-1 are arranged in a one-to-one correspondence manner. Axes of the first through holes 1221-1 coincide with the axes of the first liquid guide holes 1213-1. The plurality of third through holes 1213-3 and the plurality of third liquid guide holes 1213-3 are arranged in a one-to-one correspondence manner. Axes of the third through holes 1221-3 coincide with the axes of the third liquid guide holes 1213-3.

In an implementation, the heating element 122 includes a first heating portion 1224, a second heating portion 1225, and a third heating portion 1228 that are connected to each other, that is, the first heating portion 1224, the second heating portion 1225, and the third heating portion 1228 are controlled by a same control circuit. The first heating portion 1224 is arranged in the first atomization region 1212a-1. The second heating portion 1225 is arranged in the second atomization region 1212a-2. The third heating portion 1228 is arranged in the third atomization region 1212a-3 (as shown in FIG. 17). The resistance of the first heating portion 1224, the resistance of the second heating portion 1225, and the resistance of the third heating portion 1228 are different, and/or a heat conductivity coefficient of material of the first heating portion 1224, a heat conductivity coefficient of material of the second heating portion 1225, and a heat conductivity coefficient of material of the third heating portion 1228 are different, to cause the first atomization temperature of the first atomization region 1212a-1 to be lower than the second atomization temperature of the second atomization region 1212a-2, and the third atomization temperature of the third atomization region 1212a-3 to be lower than the first atomization temperature of the first atomization region 1212a-1. The shapes or thicknesses of the first heating portion 1224, the second heating portion 1225, and the third heating portion 1228 or a resistivity of the material may be designed to make the resistance of the first heating portion 1224, the resistance of the second heating portion 1225, and the resistance of the third heating portion 1228 different. Optionally, the resistance of the second heating portion 1225 is higher than the resistance of the first heating portion 1224, and the resistance of the first heating portion 1224 is higher than the resistance of the third heating portion 1228. Optionally, the first heating portion 1224, the second heating portion 1225, and the third heating portion 1228 are all heating films. When the first sub-substrate 121-1, the second sub-substrate 121-2, and the third sub-substrate 121-3 are made of dense material, and the first liquid guide holes 1213-1, the second liquid guide holes 1213-2, and the third liquid guide holes 1213-3 are through holes penetrating the liquid absorbing surface 1211 and the atomization surface 1212, the first heating portion 1224 has a plurality of first through holes 1221-1. The plurality of first through holes 1221-1 and the plurality of first liquid guide holes 1213-1 are arranged in a one-to-one correspondence manner. An axis of each first through hole 1221-1 coincides with the axis of the first liquid guide hole 1213-1. The second heating portion 1225 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2. The third heating portion 1228 has a plurality of third through holes 1221-3. The plurality of third through holes 1221-3 and the plurality of third liquid guide holes 1213-3 are arranged in a one-to-one correspondence manner. An axis of each third through hole 1221-3 coincides with the axis of the third liquid guide hole 1213-3.

In an implementation, the heating element 122 includes a first heating sub-element 1226, a second heating sub-element 1227, and a third heating sub-element 1229 that are independent of each other, that is, the first heating sub-element 1226, the second heating sub-element 1227, and the third heating sub-element 1229 have control circuits that are independent of each other. The first heating sub-element 1226 is arranged in the first atomization region 1212a-1. The second heating sub-element 1227 is arranged in the second atomization region 1212a-2. The third heating sub-element 1229 is arranged in the third atomization region 1212a-3 (as shown in FIG. 18). Optionally, the first heating sub-element 1226, the second heating sub-element 1227 and the third heating sub-element 1229 are both heating films. When the first sub-substrate 121-1, the second sub-substrate 121-2, and the third sub-substrate 121-3 are made of dense material, and the first liquid guide holes 1213-1, the second liquid guide holes 1213-2, and the third liquid guide holes 1213-3 are through holes penetrating the liquid absorbing surface 1211 and the atomization surface 1212, the first heating sub-element 1226 has a plurality of first through holes 1221-1. The plurality of first through holes 1221-1 and the plurality of first liquid guide holes 1213-1 are arranged in a one-to-one correspondence manner. An axis of each first through hole 1221-1 coincides with the axis of the first liquid guide hole 1213-1. The second heating sub-element 1227 has a plurality of second through holes 1221-2. The plurality of second through holes 1221-2 and the plurality of second liquid guide holes 1213-2 are arranged in a one-to-one correspondence manner. An axis of each second through hole 1221-2 coincides with the axis of the second liquid guide hole 1213-2. The third heating sub-element 1229 has a plurality of third through holes 1221-3. The plurality of third through holes 1221-3 and the plurality of third liquid guide holes 1213-3 are arranged in a one-to-one correspondence manner. An axis of each third through hole 1221-3 coincides with the axis of the third liquid guide hole 1213-3.

A structure of the heating element 122 and a position at which the heating element is arranged on the substrate 121 are designed, and a parameter of the substrate 121 is designed, such that the second atomization region 1212a-2 has a high energy density, usually ranging from 1 W/mm² to 3 W/mm². Superheat evaporation and atomization are intentionally implemented to generate a high temperature field and generate an aerosol with particles (less than 1 μm) as small as possible to quickly enter the lung and the pulmonary alveoli. Appropriate energy density is selected for the third atomization region 1212a-3, and a large-particle (2 μm to 10 μm) aerosol, rich in a sweetening agent, can be sprayed and atomized to be deposited on a tongue. Intermediate energy density is selected for the second atomization region 1212a-2, so as to generate an aerosol with a particle size about 1 μm to be effectively deposited near the throat and the nasal cavity. Based on the foregoing design principle, the heating element 122 generates a controllable temperature field in each atomization region 1212a and matches a specific medium to be atomized, and performs targeted selective atomization with a boiling point of the specific medium to be atomized and a destination of the deposited organoleptic organs as a target.

With reference to FIG. 19, FIG. 19 is a schematic diagram of a partial structure of a heating assembly of a third embodiment of an atomizer according to the present application.

The structure of the third embodiment of the atomizer 1 is basically identical to the structure of the first embodiment of the atomizer 1, and a difference is as follows: in the third embodiment of the atomizer 1, the atomizer 1 further includes a plurality of sensors 13.

Specifically, the sensors 13 are arranged on the substrate 121. The plurality of sensors 13 and the plurality of atomization regions 1212a are arranged in a one-to-one correspondence manner. It may be understood that one sensor 13 may be arranged for each atomization region 1212a, and a plurality of sensors 13 may alternatively be arranged for each atomization region 1212a, as long as it is guaranteed that a sensor 13 is arranged in each atomization region 1212a. This is specifically designed according to needs. A lead line is further arranged on the substrate 121, to electrically connect the sensor 13 to the main unit 2.

In an implementation, the substrate 121 is made of dense material, and the liquid guide holes 1213 are through holes penetrating the liquid absorbing surface 1211 and the atomization surface 1212. The sensors 13 are arranged on the walls of the liquid guide holes 1213. Optionally, a mounting groove 1213a is arranged on the wall of each liquid guide hole 1213. The sensor 13 is arranged in the mounting groove 1213a. The side surface of the sensor 13 is flush with the wall of the liquid guide hole 1213. Impact of the sensor 13 on a liquid supply speed is avoided.

In an implementation, the sensor 13 is one of a temperature sensor, a capacitance sensor, a flow sensor, and a composition sensor. The main unit 2 controls atomization according to a sensing signal. For example, electric power is adjusted to change atomization temperatures and atomization speeds of different atomization regions 1212a, and specifically, the tastes may be adjusted according to personal hobbies of the user.

It should be noted that the sensor 13 provided in the third embodiment of the atomizer 1 may also be applied to the second embodiment of the atomizer 1, and details are not described herein again. In other embodiments of the atomizer 1, the atomizer 1 includes more than three liquid storage chambers 11. The heating assembly 12 of the atomizer 1 includes more than three atomization regions 1212a. The plurality of liquid storage chambers 11 and the plurality of atomization regions 1212a are arranged in a one-to-one correspondence manner. Reference may be made to descriptions in the foregoing embodiments for specific arrangements of the liquid storage chambers 11 and the heating assembly 12, and some structures are correspondingly changed, so as to implement targeted atomization.

With reference to FIG. 20, FIG. 20 is a top-view schematic structural diagram of a liquid storage chamber of a fourth embodiment of an atomizer according to the present application.

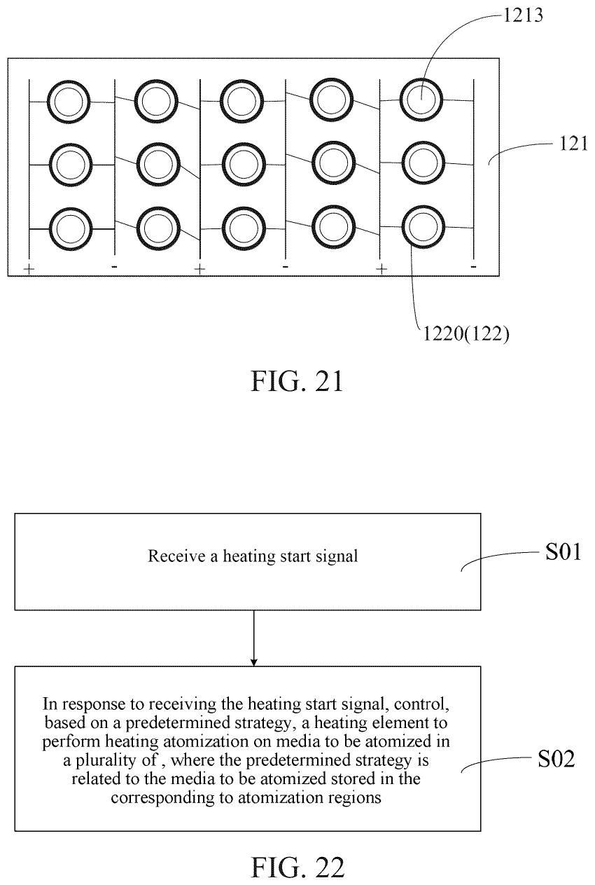

The structure of the fourth embodiment of the atomizer 1 is basically identical to the structure of the second embodiment of the atomizer 1, and a difference is as follows: the plurality of atomization regions 1212a are arranged in different manners. Specifically, in the second embodiment of the atomizer 1, the substrate 121 is rectangular, the plurality of atomization regions 1212a are arranged in parallel, and correspondingly, the plurality of liquid storage chambers 11 are also arranged in parallel. In the fourth embodiment of the atomizer 1, the substrate 121 is an annulus, for example, a circle. The plurality of atomization regions 1212a are annularly arranged, that is, the annular structure is divided into the plurality of atomization regions 1212a. Correspondingly, the plurality of liquid storage chambers 11 are also annularly arranged. Reference may be made to the description in the second embodiment of the atomizer 1 for the part in which the structure of the fourth embodiment of the atomizer 1 is the same as the structure of the second embodiment of the atomizer 1, and details are not described herein again. With reference to FIG. 21, FIG. 21 is a schematic structural diagram of an implementation of a heating element of a heating assembly according to the present application.

The present application further provides another implementation of the heating element 122 that is different from the heating element 122 of the first embodiment of the atomizer 1 and the structure of the heating element 122 of the second embodiment of the atomizer 1 in structure.

Specifically, the substrate 121 is made of dense material, and the plurality of liquid guide holes 1213 are arranged in an array. The heating element 122 includes a plurality of micro heating components 1220. The plurality of micro heating components 1220 are arranged in an array.

Optionally, each micro heating component 1220 is arranged around at least one liquid guide hole 1213 (as shown in FIG. 19). For example, the plurality of micro heating components 1220 are also arranged in an array. Each micro heating component 1220 surrounds one liquid guide hole 1213. The micro heating components 1220 in each row and/or column are independent of each other; or each micro heating component 1220 are independent of each other. That is, each micro heating component 1220 is separately controlled, or each row or column of micro heating components 1220 are separately controlled. Optionally, the plurality of micro heating components 1220 are arranged on the substrate 121, such an arrangement is similar to a circuit board.

It should be noted that the plurality of micro heating components 1220 are controlled, to cause the first atomization temperature of the first atomization region 1212a-1 to be different from the second atomization temperature (applied to the first embodiment of the atomizer 1) of the second atomization region 1212a-2, or to cause the first atomization temperature of the first atomization region 1212a-1, the second atomization temperature of the second atomization region 1212a-2, and the third atomization temperature (applied to the second embodiment of the atomizer 1) of the third atomization region 1212a-3 to be different. It may be understood that according to the number, positions, and power of the micro heating components 1220 that are selected by a control circuit to generate heat, the atomization surface 1212 may be divided into atomization regions 1212a of different numbers and sizes.

The foregoing arrangement manner of the heating assembly 12 in the first embodiment of the atomizer 1 and the arrangement manner of the heating assembly 12 in the second embodiment of the atomizer 1 are passive adjustment manner (adjustment on a temperature field is implemented by designing the parameter and the material of the substrate 121, and the material, the resistance, and an arrangement position of the heating element 122), thus on a same substrate 121, there are a plurality of different temperature fields to correspond to different media to be atomized in the plurality of liquid storage chambers 11. However, the arrangement manner of the heating element 122 provided in the implementation is an active adjustment manner (adjustment on the temperature field is implemented through active control over the plurality of micro heating components 1220), thus on a same substrate 121, there are a plurality of different temperature fields to correspond to different media to be atomized in the plurality of liquid storage chambers 11.

Furthermore, in the existing technology, a particular medium to be atomized usually has an azeotropy point between 187° C. and 290° C. For example, the medium to be atomized is a mixture of 1:1 weight ratio of propylene glycol to glycerol, and a boiling point is approximately 236° C. Atomization cannot occur in a region whose temperature is lower than the boiling point on the heating assembly, resulting in low atomization efficiency. Uniformity of the substrate of the heating assembly enables the temperature of the substrate to be controlled only by heat transfer, and under fixed surface energy, the temperature of the surface of the substrate is fixed, leading to uniqueness and unadjustability of the atomized flavor. In view of this, the present application provides a control method for heat atomization.

With reference to FIG. 22, FIG. 22 is a schematic flowchart of a control method for heating atomization according to an embodiment of the present application.

The control method for heating atomization is used for controlling an atomizer 1 to perform heating atomization. The atomizer 1 includes a plurality of liquid storage chambers 11 and a heating assembly 12. Media to be atomized are stored in the liquid storage chambers 11. Different media to be atomized are stored in different liquid storage chambers 11. The heating assembly 12 includes a substrate 121 and a heating element 122, and the heating element 122 is arranged on the atomization surface 1212 of the substrate 121; or the heating assembly 12 includes a substrate 121, and the substrate 121 is at least partially electrically conductive to serve as a heating element 122. The substrate 121 has a plurality of atomization regions 1212a, and the plurality of atomization regions 1212a and the plurality of liquid storage chambers 11 are arranged in a one-to-one correspondence manner. It should be noted that reference may be made to the introduction in the foregoing embodiment of the atomizer 1 for a specific structure of the atomizer 1. It may be understood that the control method for heating atomization in the present application is not limited to controlling the atomizer 1 in the foregoing embodiments.

The control method for heating atomization in the present application specifically includes: S01: A heating start signal is received.

Specifically, the heating start signal may be an inhaling signal, a pressing signal, a cloud signal, or the like, and is specifically designed according to requirements. S02: In response to receiving the heating start signal, based on a predetermined strategy, the heating element is controlled to perform heating atomization on the media to be atomized in the plurality of liquid storage chambers. The predetermined strategy is related to the media to be atomized stored in the liquid storage chambers corresponding to the atomization regions.

Specifically, the predetermined strategy includes: the heating element 122 is controlled to heat the plurality of atomization regions 1212a to different atomization temperatures, where the atomization temperatures of the plurality of atomization regions 1212a are in correlation with the media to be atomized corresponding to the plurality of atomization regions 1212a.

In an implementation, the heating element 122 includes a plurality of micro heating components 1220 arranged on the atomization surface 1212 of the substrate 121. A plurality of micro heating components 1220 are arranged in each atomization region 1212a. The predetermined strategy includes: the number of micro heating components 1220 that start to generate heat in the plurality of micro heating components 1220 corresponding to the different atomization regions 1212a is controlled, to heat the plurality of atomization regions 1212a to different atomization temperatures. Optionally, the substrate 121 is made of dense material. The liquid guide holes 1213 are through holes penetrating the liquid absorbing surface 1211 and the atomization surface 1212. Each micro heating component 1220 is arranged around at least one liquid guide hole 1213. A structure is shown in FIG. 21.

In an implementation, parameters of parts of the substrate 121 corresponding to different atomization regions 1212a are different. The predetermined strategy is not only related to the media to be atomized stored in the liquid storage chambers 11 corresponding to the atomization regions 1212a, but also related to the parameter (for example, the diameter of the liquid guide holes 1213, and the length of the liquid guide holes 1213) of the parts of the substrate 121 corresponding to the atomization regions 1212a.

Optionally, the substrate 121 has a plurality of liquid guide holes 1213. Liquid guide holes 1213 located in different atomization regions 1212a have different lengths. The predetermined strategy includes: the heating element 122 is controlled to heat the plurality of atomization regions 1212a to different atomization temperatures, where the atomization temperatures of the plurality of atomization regions 1212a are in positive correlation with boiling points of the media to be atomized corresponding to the plurality of atomization regions 1212a, and the atomization temperatures of the plurality of atomization regions 1212a are in positive correlation with the lengths of the liquid guide holes 1213 in the plurality of atomization regions 1212a.

Optionally, the substrate 121 has a plurality of liquid guide holes 1213. Liquid guide holes 1213 located in different atomization regions 1212a have different diameters. The predetermined strategy includes: the heating element 122 is controlled to heat the plurality of atomization regions 1212a to different atomization temperatures, where the atomization temperatures of the plurality of atomization regions 1212a are in positive correlation with boiling points of the media to be atomized corresponding to the plurality of atomization regions 1212a, and the atomization temperatures of the plurality of atomization regions 1212a are in negative correlation with the diameters of the liquid guide holes 1213 in the plurality of atomization regions 1212a.

Illustratively, the atomizer 1 includes a first liquid storage chamber 11-1 and a second liquid storage chamber 11-2. A first medium to be atomized is stored in the first liquid storage chamber 11-1. A second medium to be atomized is stored in the second liquid storage chamber 11-2. A boiling point of the first medium to be atomized is lower than a boiling point of the second medium to be atomized. The substrate 121 has a first atomization region 1212a-1 and a second atomization region 1212a-2. The first atomization region 1212a-1 is arranged corresponding to the first liquid storage chamber 11-1, and the second atomization region 1212a-2 is arranged corresponding to the second liquid storage chamber 11-2. The substrate 121 has a plurality of first liquid guide holes 1213-1 located in the first atomization region 1212a-1 and a plurality of second liquid guide holes 1213-2 located in the second atomization region 1212a-2. The diameter of the first liquid guide holes 1213-1 is greater than the diameter of the second liquid guide holes 1213-2, and/or the length of the first liquid guide holes 1213-1 is less than the length of the second liquid guide holes 1213-2. It should be noted that reference may be made to the first embodiment of the atomizer 1 described above for detailed descriptions of a structure of the atomizer 1 in the implementation, and details are not described herein again. In this case, the predetermined strategy includes: the first atomization region 1212a-1 is heated to a first atomization temperature to atomize the first medium to be atomized, and the second atomization region 1212a-2 is heated to a second atomization temperature to atomize the second medium to be atomized, where the first atomization temperature is lower than the second atomization temperature.

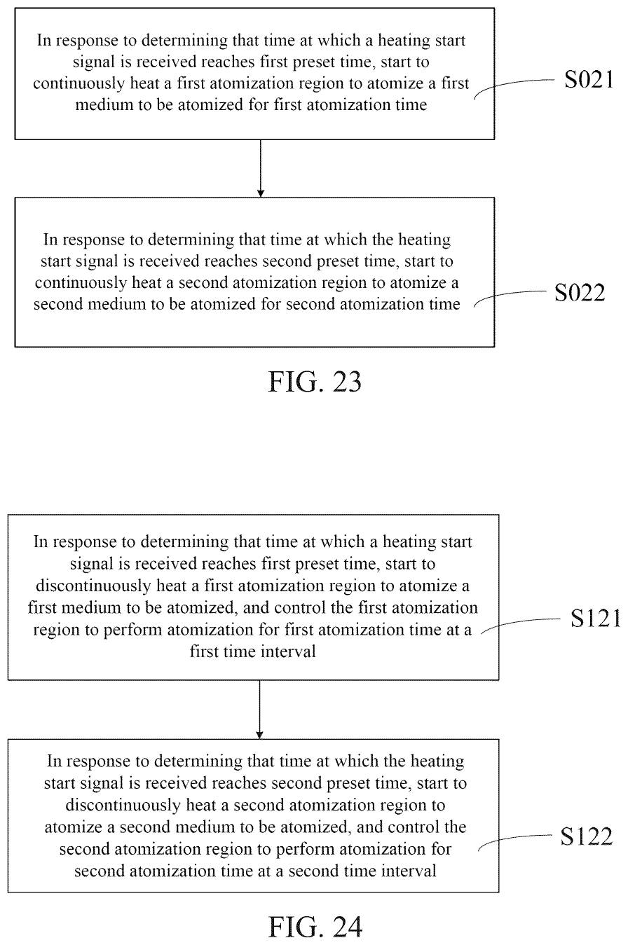

With reference to FIG. 23, FIG. 23 is a schematic flowchart of an implementation of S02 of the control method for heating atomization provided in FIG. 22. In an embodiment, the first atomization region 1212a-1 is heated to the first atomization temperature to atomize the first medium to be atomized, and the second atomization region 1212a-2 is heated to the second atomization temperature to atomize the second medium to be atomized. Specifically, this process includes:

S021: In response to determining that time at which the heating start signal is received reaches first preset time, it is started to continuously heat the first atomization region to atomize the first medium to be atomized for first atomization time.

S022: In response to determining that time at which the heating start signal is received reaches second preset time, it is started to continuously heat the second atomization region to atomize the second medium to be atomized for second atomization time.

The first preset time is equal to the second preset time, that is, the time at which the heating start signal is received reaches the same time, and the first atomization region 1212a-1 and the second atomization region 1212a-2 start to be heated simultaneously. For example, the first preset time and the second preset time are both 0. For another example, the first preset time is equal to the second preset time, the second preset time is greater than 0 and less than a first time threshold, and the first time threshold ranges from 2 s to 5 s; or the first preset time is greater than the second preset time. It may be understood that since the first atomization temperature is lower than the second atomization temperature, it takes longer time to rise to the second atomization temperature. The first preset time is set to be greater than the second preset time, thus the first atomization region 1212a-1 and the second atomization region 1212a-2 are almost simultaneously heated to the corresponding atomization temperature, and release the aerosols simultaneously, to improve the tastes. For example, the second preset time is greater than 0 and less than the first time threshold, the first preset time is greater than the second preset time and less than the first time threshold, and the first time threshold ranges from 2 s to 5 s.

And/or, the first atomization time is equal to the second atomization time or not. Preferably, the first atomization time is equal to the second atomization time, and the first atomization region 1212a-1 and the second atomization region 1212a-2 always release the aerosols simultaneously, to improve the tastes. Optionally, the first atomization time is a fixed value, or the first atomization time is time from a start of atomization in the first atomization region 1212a-1 to an end of inhaling. Optionally, the second atomization time is a fixed value, or the second atomization time is time from a start of atomization in the second atomization region 1212a-2 to an end of inhaling. It should be noted that the end of inhaling refers to that the end of inhaling is determined in a case where it is detected that an inhaling interval is greater than a threshold. The threshold is interval duration between this inhaling and next inhaling in a normal continuous inhaling process.

It may be understood that the first preset time, the second preset time, the first atomization time, and the second atomization time are specifically designed according to requirements of a user on a taste and a flavor.

With reference to FIG. 24, FIG. 24 is a schematic flowchart of another implementation of S02 of the control method for heating atomization provided in FIG. 22. In an embodiment, the first atomization region 1212a-1 is heated to the first atomization temperature to atomize the first medium to be atomized, and the second atomization region 1212a-2 is heated to the second atomization temperature to atomize the second medium to be atomized. Specifically, this process includes:

S121: In response to determining that time at which the heating start signal is received reaches first preset time, it is started to discontinuously heat the first atomization region to atomize the first medium to be atomized, and the first atomization region is controlled to perform atomization for first atomization time at a first time interval.

S122: In response to determining that time at which the heating start signal is received reaches second preset time, it is started to discontinuously heat the second atomization region to atomize the second medium to be atomized, and the second atomization region is controlled to perform atomization for second atomization time at a second time interval.

The first preset time is equal to the second preset time, that is, the time at which the heating start signal is received reaches the same time, and the first atomization region 1212a-1 and the second atomization region 1212a-2 start to be heated simultaneously. For example, the first preset time and the second preset time are both 0. For another example, the first preset time is equal to the second preset time, the second preset time is greater than 0 and less than a first time threshold, and the first time threshold ranges from 2 s to 5 s; or the first preset time is greater than the second preset time. It may be understood that since the first atomization temperature is lower than the second atomization temperature, it takes longer time to rise to the second atomization temperature. The first preset time is set to be greater than the second preset time, thus the first atomization region 1212a-1 and the second atomization region 1212a-2 are almost simultaneously heated to the corresponding atomization temperature, and release the aerosols simultaneously, to improve the tastes. For example, the second preset time is greater than 0 and less than the first time threshold, the first preset time is greater than the second preset time and less than the first time threshold, and the first time threshold ranges from 2 s to 5 s.

And/or, the first atomization time is equal to the second atomization time or not. And/or, the first time interval is equal to the second time interval or not.

It may be understood that the first preset time, the first time interval, the first atomization time, the second preset time, the second time interval, and the second atomization time are specifically designed according to requirements of a user on a taste and a flavor.

Illustratively, the atomizer 1 includes a first liquid storage chamber 11-1, a second liquid storage chamber 11-2, and a third liquid storage chamber 11-3. A first medium to be atomized is stored in the first liquid storage chamber 11-1. A second medium to be atomized is stored in the second liquid storage chamber 11-2. A third medium to be atomized is stored in the third liquid storage chamber 11-3. A boiling point of the first medium to be atomized is lower than a boiling point of the second medium to be atomized. The boiling point of the second medium to be atomized is lower than a boiling point of the third medium to be atomized. The substrate 121 has a first atomization region 1212a-1, a second atomization region 1212a-2, and a third atomization region 1212a-3. The first atomization region 1212a-1 is arranged corresponding to the first liquid storage chamber 11-1, the second atomization region 1212a-2 is arranged corresponding to the second liquid storage chamber 11-2, and the third atomization region 1212a-3 is arranged corresponding to the third liquid storage chamber 11-3. The substrate 121 has a plurality of first liquid guide holes 1213-1 located in the first atomization region 1212a-1, a plurality of second liquid guide holes 1213-2 located in the second atomization region 1212a-2, and a plurality of third liquid guide holes 1213-3 located in the third atomization region 1212a-3, the diameter of the first liquid guide holes 1213-1 is greater than the diameter of the second liquid guide holes 1213-2, and the diameter of the second liquid guide holes 1213-2 is greater than the diameter of the third liquid guide holes 1213-3; and/or the length of the first liquid guide holes 1213-1 is less than the length of the second liquid guide holes 1213-2, and the length of the second liquid guide holes 1213-2 is less than the length of the third liquid guide holes 1213-3. It should be noted that reference may be made to the second embodiment of the atomizer 1 described above for detailed descriptions of a structure of the atomizer 1 in the implementation, and details are not described herein again. In this case, the predetermined strategy includes: the first atomization region 1212a-1 is heated to a first atomization temperature to atomize the first medium to be atomized, the second atomization region 1212a-2 is heated to a second atomization temperature to atomize the second medium to be atomized, and the third atomization region 1212a-3 is heated to a third atomization temperature to atomize the third medium to be atomized, where the first atomization temperature is lower than the second atomization temperature, and the second atomization temperature is lower than the third atomization temperature.

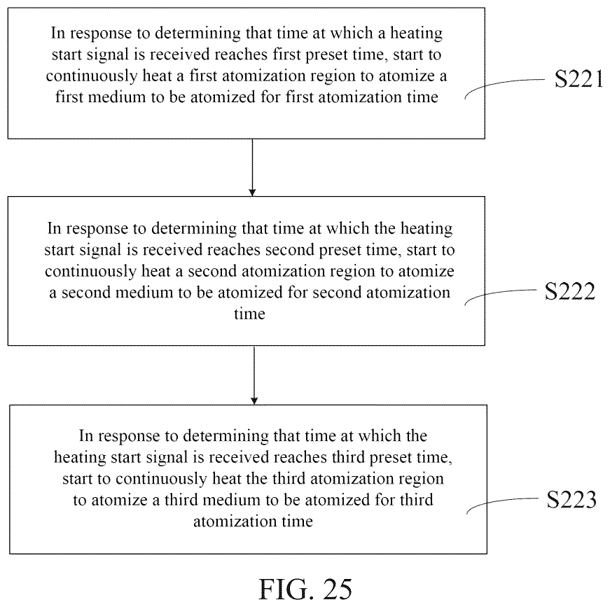

With reference to FIG. 25, FIG. 25 is a schematic flowchart of still another implementation of S02 of the control method for heating atomization provided in FIG. 22. In an embodiment, the first atomization region 1212a-1 is heated to the first atomization temperature to atomize the first medium to be atomized, the second atomization region 1212a-2 is heated to the second atomization temperature to atomize the second medium to be atomized, and the third atomization region 1212a-3 is heated to the third atomization temperature to atomize the third medium to be atomized. Specifically, this process includes:

S221: In response to determining that time at which the heating start signal is received reaches first preset time, it is started to continuously heat the first atomization region to atomize the first medium to be atomized for first atomization time.

S222: In response to determining that time at which the heating start signal is received reaches second preset time, it is started to continuously heat the second atomization region to atomize the second medium to be atomized for second atomization time.

S223: In response to determining that time at which the heating start signal is received reaches third preset time, it is started to continuously heat the third atomization region to atomize the third medium to be atomized for third atomization time.

The first preset time, the second preset time, and the third preset time are equal, that is, the time at which the heating start signal is received reaches the same time, and the first atomization region 1212a-1, the second atomization region 1212a-2 and the third atomization region 1212a-3 start to be heated simultaneously. For example, the first preset time, the second preset time, and the third preset time are all 0; or the first preset time is greater than the second preset time, and the second preset time is greater than the third preset time. It may be understood that since the first atomization temperature is lower than the second atomization temperature and the second atomization temperature is lower than the third atomization temperature, compared with the first atomization temperature, it takes longer time to rise to the second atomization temperature and the third atomization temperature. The first preset time is set to be greater than the second preset time, and the second preset time is greater than the third preset time, thus the first atomization region 1212a-1, the second atomization region 1212a-2, and the third atomization region 1212a-3 are almost simultaneously heated to the corresponding atomization temperatures, and release the aerosols simultaneously, to improve the tastes. For example, the third preset time is 0, the second preset time is greater than 0 and less than the first time threshold, the first preset time is greater than the second preset time and less than the first time threshold, and the first time threshold ranges from 2 s to 5 s; or the first preset time is greater than the second preset time, and the second preset time is greater than the third preset time. It may be understood that since the first atomization temperature is lower than the second atomization temperature and the second atomization temperature is lower than the third atomization temperature, compared with the first atomization temperature and the second atomization temperature, it takes longer time to rise to the third atomization temperature. The first preset time is set to be equal to the second preset time, and the second preset time is greater than the third preset time, thus the tastes are improved. For example, the third preset time is 0, the first preset time is equal to the second preset time, the second preset time is greater than 0 and less than the first time threshold, and the first time threshold ranges from 2 s to 5 s.

And/or, the first atomization time, the second atomization time, and the third atomization time are equal, or at least two of the first atomization time, the second atomization time, and the third atomization time are different. Preferably, the first atomization time, the second atomization time, and the third atomization time are equal. The first atomization region 1212a-1, the second atomization region 1212a-2, and the third atomization region 1212a-3 all release the aerosols simultaneously, to improving the tastes. Optionally, the first atomization time is a fixed value, or the first atomization time is time from a start of atomization in the first atomization region 1212a-1 to an end of inhaling. Optionally, the second atomization time is a fixed value, or the second atomization time is time from a start of atomization in the second atomization region 1212a-2 to an end of inhaling. Optionally, the third atomization time is a fixed value, or the third atomization time is time from a start of atomization in the third atomization region 1212a-3 to an end of inhaling. It should be noted that the end of inhaling refers to that the end of inhaling is determined in a case where it is detected that an inhaling interval is greater than a threshold. The threshold is interval duration between this inhaling and next inhaling in a normal continuous inhaling process.

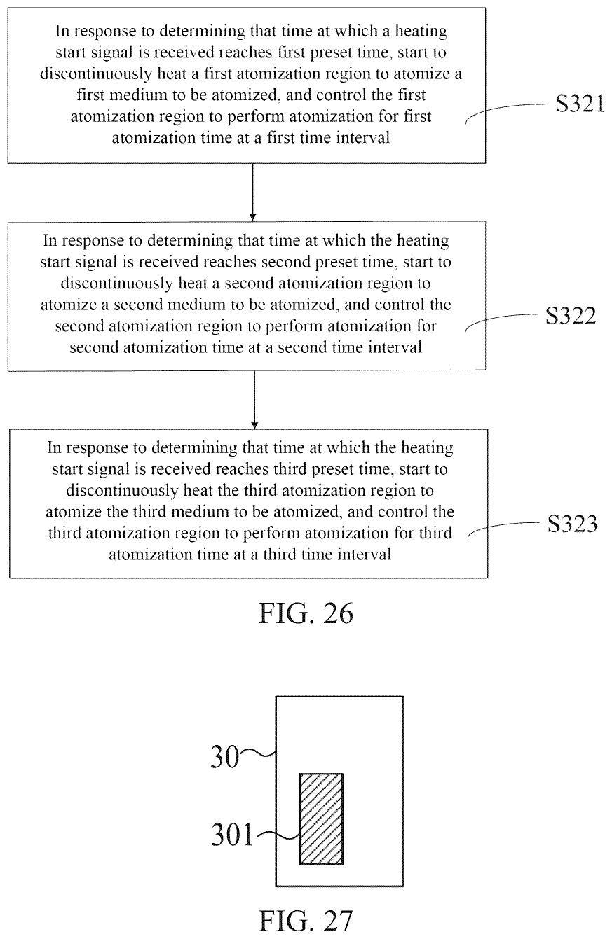

With reference to FIG. 26, FIG. 26 is a schematic flowchart of still another implementation of S02 of the control method for heating atomization provided in FIG. 22. In an embodiment, the first atomization region 1212a-1 is heated to the first atomization temperature to atomize the first medium to be atomized, the second atomization region 1212a-2 is heated to the second atomization temperature to atomize the second medium to be atomized, and the third atomization region 1212a-3 is heated to the third atomization temperature to atomize the third medium to be atomized. Specifically, this process includes:

S321: In response to determining that time at which the heating start signal is received reaches first preset time, it is started to discontinuously heat the first atomization region to atomize the first medium to be atomized, and the first atomization region is controlled to perform atomization for first atomization time at a first time interval.

S322: In response to determining that time at which the heating start signal is received reaches second preset time, it is started to discontinuously heat the second atomization region to atomize the second medium to be atomized, and the second atomization region is controlled to perform atomization for second atomization time at a second time interval.

S323: In response to determining that time at which the heating start signal is received reaches third preset time, it is started to discontinuously heat the third atomization region to atomize the third medium to be atomized, and the third atomization region is controlled to perform atomization for third atomization time at a third time interval.

The first preset time, the second preset time, and the third preset time are equal, that is, the time at which the heating start signal is received reaches the same time, and the first atomization region 1212a-1, the second atomization region 1212a-2 and the third atomization region 1212a-3 start to be heated simultaneously. For example, the first preset time, the second preset time, and the third preset time are all 0; or the first preset time is greater than the second preset time, and the second preset time is greater than the third preset time. It may be understood that since the first atomization temperature is lower than the second atomization temperature and the second atomization temperature is lower than the third atomization temperature, compared with the first atomization temperature, it takes longer time to rise to the second atomization temperature and the third atomization temperature. The first preset time is set to be greater than the second preset time, and the second preset time is greater than the third preset time, thus the first atomization region 1212a-1, the second atomization region 1212a-2, and the third atomization region 1212a-3 are almost simultaneously heated to the corresponding atomization temperatures, and release the aerosols simultaneously, to improve the tastes. For example, the third preset time is 0, the second preset time is greater than 0 and less than the first time threshold, the first preset time is greater than the second preset time and less than the first time threshold, and the first time threshold ranges from 2 s to 5 s; or the first preset time is greater than the second preset time, and the second preset time is greater than the third preset time. It may be understood that since the first atomization temperature is lower than the second atomization temperature and the second atomization temperature is lower than the third atomization temperature, compared with the first atomization temperature and the second atomization temperature, it takes longer time to rise to the third atomization temperature. The first preset time is set to be equal to the second preset time, and the second preset time is greater than the third preset time, thus the tastes are improved. For example, the third preset time is 0, the first preset time is equal to the second preset time, the second preset time is greater than 0 and less than the first time threshold, and the first time threshold ranges from 2 s to 5 s.

And/or, at least two of the first atomization time, the second atomization time, and the third atomization time are different, or the first atomization time, the second atomization time, and the third atomization time are equal.

And/or, at least two of the first time interval, the second time interval, and the third time interval are different, or the first time interval, the second time interval, and the third time interval are equal.

It may be understood that, the first preset time, the first time interval, the first atomization time, the second preset time, the second time interval, the second atomization time, the third preset time, the third time interval, and the third atomization time are specifically designed according to requirements of a user on a taste and a flavor.

In an implementation, the predetermined strategy is merely related to the media to be atomized stored in the liquid storage chambers 11 corresponding to the atomization regions 1212a.

Illustratively, the atomizer 1 includes a first liquid storage chamber 11-1, a second liquid storage chamber 11-2, and a third liquid storage chamber 11-3. A first medium to be atomized is stored in the first liquid storage chamber 11-1. A second medium to be atomized is stored in the second liquid storage chamber 11-2. A third medium to be atomized is stored in the third liquid storage chamber 11-3. A boiling point of the first medium to be atomized is lower than a boiling point of the second medium to be atomized. The boiling point of the second medium to be atomized is lower than a boiling point of the third medium to be atomized. The first medium to be atomized and the second medium to be atomized both comprise propylene glycol and glycerol. Contents of the propylene glycol and the glycerol in the first medium to be atomized are different from those in the second medium to be atomized. The third medium to be atomized includes a sweetening agent. The substrate 121 has a first atomization region 1212a-1, a second atomization region 1212a-2, and a third atomization region 1212a-3. The first atomization region 1212a-1 is arranged corresponding to the first liquid storage chamber 11-1, the second atomization region 1212a-2 is arranged corresponding to the second liquid storage chamber 11-2, and the third atomization region 1212a-3 is arranged corresponding to the third liquid storage chamber 11-3. The substrate 121 has a plurality of first liquid guide holes 1213-1 located in the first atomization region 1212a-1, a plurality of second liquid guide holes 1213-2 located in the second atomization region 1212a-2, and a plurality of third liquid guide holes 1213-3 located in the third atomization region 1212a-3. The diameter of the first liquid guide holes 1213-1 is greater than the diameter of the second liquid guide holes 1213-3, and/or the length of the first liquid guide holes 1213-1 is less than the length of the second liquid guide holes 1213-2. It should be noted that reference may be made to the second embodiment of the atomizer 1 described above for detailed descriptions of a structure of the atomizer 1 in the implementation, and details are not described herein again. In this case, the predetermined strategy includes: the first atomization region 1212a-1 is heated to a first atomization temperature to atomize the first medium to be atomized, the second atomization region 1212a-2 is heated to a second atomization temperature to atomize the second medium to be atomized, and the third atomization region 1212a-3 is heated to a third atomization temperature to atomize the third medium to be atomized. The first atomization temperature is lower than the second atomization temperature, and the third atomization temperature is lower than the first atomization temperature; or the first atomization temperature is lower than the second atomization temperature, and the third atomization temperature is higher than the first atomization temperature and lower than the second atomization temperature.

A specific implementation of the predetermined strategy may use a manner shown in FIG. 25, or may use a manner shown in FIG. 26. A relationship among the first preset time, the second preset time, and the third preset time needs to be correspondingly modified. The first preset time, the second preset time, and the third preset time are equal when the first atomization temperature is lower than the second atomization temperature and the third atomization temperature is lower than the first atomization temperature; or the third preset time is equal to the first preset time, and the first preset time is greater than the second preset time; or the third preset time is greater than the first preset time, and the first preset time is greater than the second preset time. The first preset time, the second preset time, and the third preset time are equal when the first atomization temperature is lower than the second atomization temperature, and the third atomization temperature is higher than the first atomization temperature and lower than the second atomization temperature; or the third preset time is equal to the first preset time, and the first preset time is greater than the second preset time; or the first preset time is greater than the third preset time, and the third preset time is greater than the second preset time.

It should be noted that according to the control method for heating atomization according to any one of the foregoing embodiments provided in the present application, a temperature field of each micro structure (the micro structure may be an atomization region 1212a, or may be a liquid guide hole 1213) is actively controlled by using a plurality of micro heat circuits (the plurality of micro heating components 1220, and independent control in a plurality of rows and/or a plurality of columns of the plurality of micro heating components 1220), and different media to be atomized are matched according to the boiling points and the particle sizes of the aerosols that need to be formed, so as to finally atomize the target in a target manner.

With still reference to FIG. 1, the main unit 2 of the electronic atomization device 100 further includes a memory 23. The memory 23 is used for storing program instructions for implementing the control method for heating atomization of any one of the embodiments described above. The processor 22 is used for executing the program instructions stored in the memory 23. That is, the processor 22 calls the program instructions stored in the memory 23 from the memory 23 to implement the control method for heating atomization of any one of the embodiments described above.

The processor 22 also may be referred to as a central processing unit (CPU). The processor 22 may be an integrated circuit chip with a signal processing capability. The processor 22 may further be a general-purpose processor, a digital signal processor (DSP), an application specific integrated circuit (ASIC), a field programmable gate array (FPGA) or other programmable logic devices, a discrete gate or a transistor logic device, a discrete hardware component. The general-purpose processor may be a microprocessor, or the processor may be any conventional processor or the like.

The memory 23 may be a memory stick, a TF card or the like, and may store all information in the electronic device of the device, including input original data, a computer program, an intermediate running result and a final running result, all stored in the memory. The memory stores and reads the information according to a position determined by a controller. With the memory 23, the apparatus has a memory function, so as to guarantee normal operation. The memory 23 may be divided into a main memory (internal memory) and an auxiliary memory (external memory) according to the purpose. There is also a classification method dividing the memory into an external memory and an internal memory. The external memory usually is a magnetic medium or an optical disk or the like, which can store information for a long time. The internal memory refers to the storage component on a mainboard, configured to store data and programs being executed currently, but merely configured to store the programs and the data temporarily. The data is lost when the power is turned off or there is a power failure.

With reference to FIG. 27, FIG. 27 is a schematic block diagram of a computer-readable storage medium according to an embodiment of the present application. The computer-readable storage medium 30 stores program instruction s301 that may be executed by the processor. The program instructions 301 are used for implementing steps of the control method for heating atomization according to any one of the foregoing embodiments. In some embodiments, the functions or modules encompassed in the device according to the example of the disclosure may be used to implement the above control method for heating atomization, and reference may be made to the description of the above method embodiments for specific implementations, which will not be repeated herein for brevity.

The foregoing descriptions of the embodiments are intended to emphasize differences between the embodiments. Mutual reference may be made to the same or similar parts, which will not be repeated herein for brevity.

In the several embodiments provided in the present application, it should be understood that the disclosed method and device may be implemented in other manners. For example, the described device implementation is merely illustrative. For example, the division of modules or units is merely a logical function division and may be other division during actual implementation. For example, units or assemblies may be combined or integrated into another system, or some features may be ignored or not performed. Furthermore, coupling or direct coupling or communication connection between each other as shown or discussed can be achieved by means of some interfaces, and indirect coupling or communication connection between apparatuses or units can be in an electrical form, a mechanical form or other forms.

In addition, functional units in the embodiments of this application may be integrated into one processing unit, or each of the units may be physically separated, or two or more units may be integrated into one unit. The integrated unit may be implemented in the form of hardware, or may be implemented in a form of a software functional unit.

When the integrated unit is implemented in the form of a software functional unit and sold or used as an independent product, the integrated unit may be stored in a computer-readable storage medium. Based on such understanding, the technical solutions of the present application essentially, or the part contributing to the related art, or all or some of the technical solutions may be implemented in the form of a software product. The computer software product is stored in a storage medium and includes several instructions for instructing a computer apparatus (which may be a personal computer, a server, a network device, or the like) or a processor to perform all or some of the steps of the methods described in the implementations of the present application. The foregoing storage medium includes: various media capable of storing a program code, such as a universal serial bus (USB) flash disk, a mobile hard disk, a read-only memory (ROM), a random access memory (RAM), a magnetic disk, or an optical disk.

The following separately describes an atomizer having two liquid storage chambers and two atomization regions and an atomizer having three liquid storage chambers and three atomization regions provided in the present application as different specific embodiments.

### Embodiment 1

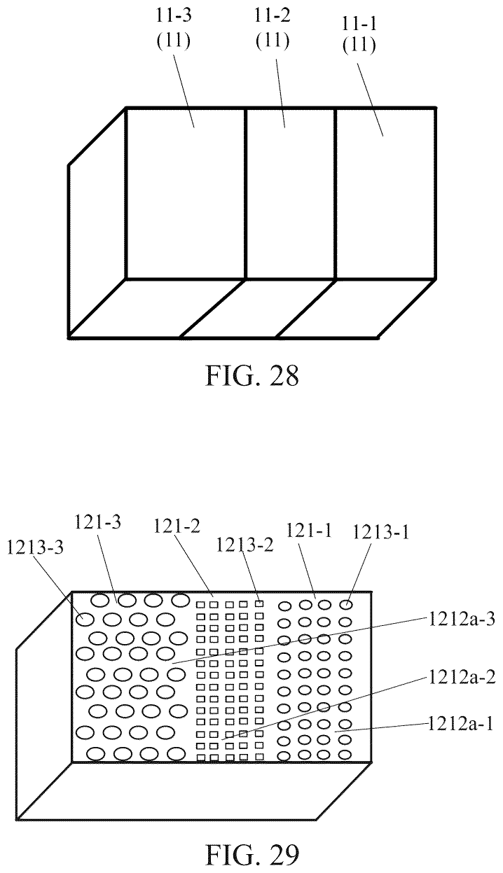

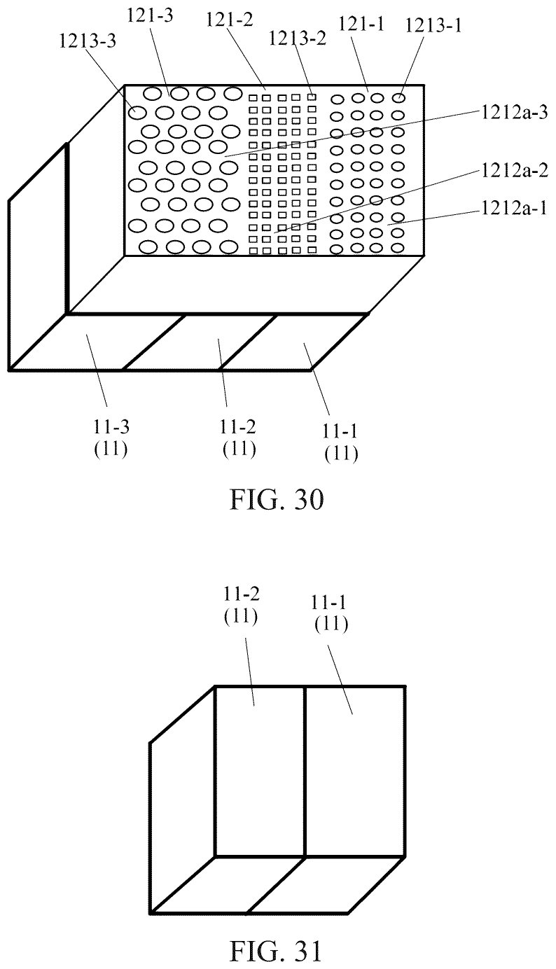

With reference to FIG. 28 to FIG. 30, FIG. 28 is a schematic structural diagram of a liquid storage chamber according to specific embodiment 1 of the present disclosure. FIG. 29 is a schematic structural diagram of a substrate of a heating assembly according to specific embodiment 1 of the present application. FIG. 30 is a schematic structural diagram after a liquid storage chamber and a substrate of a heating assembly are assembled according to specific embodiment 1 of the present application.

As shown in FIG. 28 to FIG. 30, the atomizer includes three liquid storage chambers 11, which are a first liquid storage chamber 11-1, a second liquid storage chamber 11-2, and a third liquid storage chamber 11-3 respectively. A first medium to be atomized is stored in the first liquid storage chamber 11-1. A second medium to be atomized is stored in the second liquid storage chamber 11-2. A third medium to be atomized is stored in the third liquid storage chamber 11-3. A boiling point of the first medium to be atomized is lower than a boiling point of the second medium to be atomized, and the boiling point of the second medium to be atomized is lower than a boiling point of the third medium to be atomized. The boiling point of the first medium to be atomized ranges from 20° C. to 250° C., the boiling point of the second medium to be atomized ranges from 250° C. to 360° C., and the boiling point of the third medium to be atomized ranges from 400° C. to 600° C. The first medium to be atomized includes propylene glycol, glycerol, and a low-boiling-point aroma substance. The second medium to be atomized includes propylene glycol, glycerol, and a high-boiling-point aroma substance. The third medium to be atomized includes a sweetening agent. Contents of the propylene glycol and the glycerol in the first medium to be atomized are different from those in the second medium to be atomized. The substrate 121 includes a first sub-substrate 121-1, a second sub-substrate 121-2, and a third sub-substrate 121-3 that are connected to each other. The first sub-substrate 121-1 has a first atomization region 1212a-1. The second sub-substrate 121-2 has a second atomization region 1212a-2. The third sub-substrate 121-3 has a third atomization region 1212a-3. The first liquid storage chamber 11-1 is arranged corresponding to the first atomization region 1212a-1. The second liquid storage chamber 11-2 is arranged corresponding to the second atomization region 1212a-2. The third liquid storage chamber 11-3 is arranged corresponding to the third atomization region 1212a-3.

The heating element (not shown in FIG. 28 to FIG. 30) is used for heating the first atomization region 1212a-1 to a first atomization temperature, heating the second atomization region 1212a-2 to a second atomization temperature, and heating the third atomization region 1212a-3 to a third atomization temperature. The first atomization temperature is lower than the second atomization temperature, and the second atomization temperature is lower than the third atomization temperature. The first atomization temperature is an average temperature of the first atomization region 1212a-1. The second atomization temperature is an average temperature of the second atomization region 1212a-2. The third atomization temperature is an average temperature of the third atomization region 1212a-3.

The first sub-substrate 121-1 has a plurality of first liquid guide holes 1213-1. The second sub-substrate 121-2 has a plurality of second liquid guide holes 1213-2. The third sub-substrate 121-3 has a plurality of third liquid guide holes 1213-3. The diameter of the first liquid guide holes 1213-1 is greater than or equal to 20 μm, the diameter of the second liquid guide holes 1213-2 is less than or equal to 30 μm, and the diameter of the third liquid guide holes 1213-3 is greater than 20 μm. The first sub-substrate 121-1, the second sub-substrate 121-2, and the third sub-substrate 121-3 have identical thickness. The diameter of the first liquid guide hole 1213-1 is greater than the diameter of the second liquid guide hole 1213-2, and the diameter of the third liquid guide hole 1213-3 is greater than the diameter of the first liquid guide hole 1213-1. Specifically, the diameter of the first liquid guide holes 1213-1 is greater than or equal to 30 μm, the diameter of the second liquid guide holes 1213-2 is less than or equal to 20 μm, and the diameter of the third liquid guide holes 1213-3 is greater than 30 μm. A ratio of the thickness of the first sub-substrate 121-1 to the diameter of the first liquid guide holes 1213-1 is less than 10:1. A ratio of the thickness of the second sub-substrate 121-2 to the diameter of the second liquid guide holes 1213-2 is greater than 10:1. A ratio of the thickness of the third sub-substrate 121-3 to the diameter of the third liquid guide holes 1213-3 is less than 8:1. The first liquid guide holes 1213-1 and the third liquid guide holes 1213-3 are circular holes. The second liquid guide holes 1213-2 are square holes. The plurality of first liquid guide holes 1213-1 and the plurality of second liquid guide holes 1213-2 are arranged in an array. The plurality of third liquid guide holes 1213-3 are arranged in an array and are staggered in two adjacent rows.

The thickness of the first sub-substrate 121-1 is equal to the thickness of the second sub-substrate 121-2, and the diameter of the first liquid guide holes 1213-1 is greater than the diameter of the second liquid guide holes 1213-2, a liquid supply speed of the first liquid guide holes 1213-1 is greater than a liquid supply speed of the second liquid guide holes 1213-2, and the first atomization temperature of the first atomization region 1212a-1 is lower than the second atomization temperature of the second atomization region 1212a-2. Aerosols of different flavors are formed through atomization in the first atomization region 1212a-1 and the second atomization region 1212a-2 respectively, and the aerosols of different flavors are mixed and are inhaled by a user.

Since the third medium to be atomized includes a sweetening agent, and needs to be atomized to form large-particle aerosols, the diameter of the third liquid guide holes 1213-3 is greater than the diameter of the first liquid guide holes 1213-1 and the diameter of the second liquid guide holes 1213-2. However, since the third medium to be atomized has a better boiling point, the third atomization temperature of the third atomization region 1212a-3 needs to be higher than both the first atomization temperature and the second atomization temperature. Thus in the embodiment, by controlling the arrangement manner or the power supply of the heating element, the third atomization temperature of the third atomization region 1212a-3 is higher than the first atomization temperature and the second atomization temperature.

In the embodiment, the heating element includes a first heating sub-element, a second heating sub-element, and a third heating sub-element that are independent of each other. The first heating sub-element is arranged in the first atomization region 1212a-1. The second heating sub-element is arranged in the second atomization region 1212a-2. The third heating sub-element is arranged in the third atomization region 1212a-3. In response to receiving an inhaling signal, the main unit 2 controls the third heating sub-element to first start to generate heat for a period of time. Then, the main unit 2 controls the first heating sub-element and the second heating sub-element to start to generate heat. Since the third heating sub-element starts to generate heat in advance, the third atomization temperature of the third atomization region 1212a-3 is higher than the first atomization temperature and the second atomization temperature. The diameter of the first liquid guide holes 1213-1 is greater than the diameter of the second liquid guide holes 1213-2, a liquid supply speed of the first liquid guide holes 1213-1 is greater than a liquid supply speed of the second liquid guide holes 1213-2, and the first atomization temperature of the first atomization region 1212a-1 is lower than the second atomization temperature of the second atomization region 1212a-2. Specifically, in the embodiment, the first atomization temperature ranges from 200° C. to 250° C., the second atomization temperature ranges from 250° C. to 350° C., and the third atomization temperature ranges from 400° C. to 550° C.

### Embodiment 2

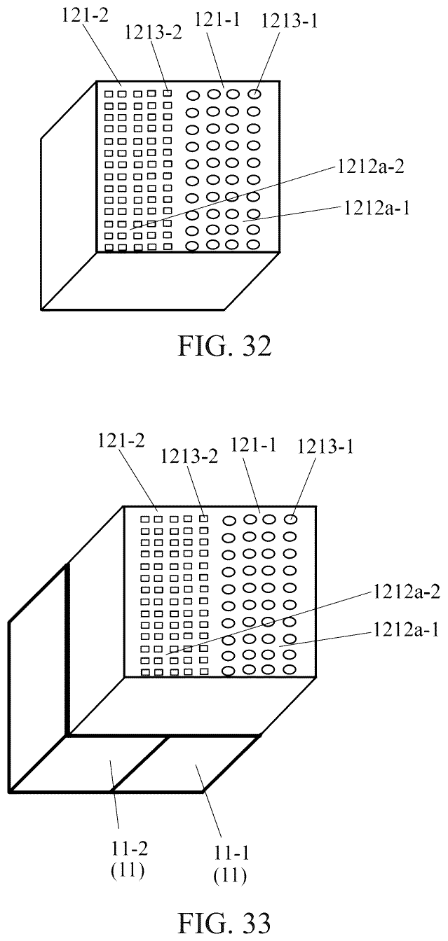

With reference to FIG. 31 to FIG. 33, FIG. 31 is a schematic structural diagram of a liquid storage chamber according to specific embodiment 2 of the present disclosure. FIG. 32 is a schematic structural diagram of a substrate of a heating assembly according to specific embodiment 2 of the present application. FIG. 33 is a schematic structural diagram after a liquid storage chamber and a substrate of a heating assembly are assembled according to specific embodiment 2 of the present application.

With reference to FIG. 31 to FIG. 33, the structure of the atomizer provided in Embodiment 2 is basically the same as the structure of the atomizer provided in Embodiment 1. A difference is as follows: the atomizer provided in Embodiment 2 includes merely two liquid storage chambers 11, and the substrate 121 includes merely two sub-substrates.

Specifically, the atomizer provided in Embodiment 2 includes two liquid storage chambers 11, which are a first liquid storage chamber 11-1 and a second liquid storage chamber 11-2 respectively. A first medium to be atomized is stored in the first liquid storage chamber 11-1. A second medium to be atomized is stored in the second liquid storage chamber 11-2. The boiling point of the first medium to be atomized is lower than the boiling point of the second medium to be atomized. Specifically, the boiling point of the first medium to be atomized ranges from 20° C. to 250° C., and the boiling point of the second medium to be atomized ranges from 250° C. to 360° C. The first medium to be atomized includes propylene glycol, glycerol, and a low-boiling-point aroma substance. The second medium to be atomized includes propylene glycol, glycerol, and a high-boiling-point aroma substance. Contents of the propylene glycol and the glycerol in the first medium to be atomized are different from those in the second medium to be atomized. The content of the propylene glycol in the first medium to be atomized is greater than the content of the glycerol. The content of the propylene glycol in the second medium to be atomized is less than the content of the glycerol. The low-boiling-point aroma substance includes nicotine or nicotine salt. The high-boiling-point aroma substance includes a plant extract.

The substrate 121 of the heating assembly includes a first sub-substrate 121-1 and a second sub-substrate 121-2 that are connected to each other. The first sub-substrate 121-1 has a first atomization region 1212a-1. The second sub-substrate 121-2 has a second atomization region 1212a-2. The first liquid storage chamber 11-1 is arranged corresponding to the first atomization region 1212a-1. The second liquid storage chamber 11-2 is arranged corresponding to the second atomization region 1212a-2. The heating element (not shown in FIG. 28 to FIG. 30) is used for heating the first atomization region 1212a-1 to a first atomization temperature, and heating the second atomization region 1212a-2 to a second atomization temperature. The first atomization temperature is lower than the second atomization temperature. The first atomization temperature is an average temperature of the first atomization region 1212a-1. The second atomization temperature is an average temperature of the second atomization region 1212a-2.

The first sub-substrate 121-1 has a plurality of first liquid guide holes 1213-1, and the second sub-substrate 121-2 has a plurality of second liquid guide holes 1213-2. The diameter of the first liquid guide holes 1213-1 is greater than or equal to 20 μm, and the diameter of the second liquid guide holes 1213-2 is less than or equal to 30 μm. The thickness of the first sub-substrate 121-1 is equal to the thickness of the second sub-substrate 121-2, and the diameter of the first liquid guide holes 1213-1 is greater than the diameter of the second liquid guide holes 1213-2. Specifically, the first liquid guide holes 1213-1 are circular holes. The second liquid guide holes 1213-2 are square holes. The diameter of the first liquid guide holes 1213-1 is greater than or equal to 30 μm, and the diameter of the second liquid guide holes 1213-2 is less than or equal to 20 μm. A ratio of the thickness of the first sub-substrate 121-1 to the diameter of the first liquid guide holes 1213-1 is less than 10:1. A ratio of the thickness of the second sub-substrate 121-2 to the diameter of the second liquid guide holes 1213-2 is greater than 10:1.

The thickness of the first sub-substrate 121-1 is equal to the thickness of the second sub-substrate 121-2, and the diameter of the first liquid guide holes 1213-1 is greater than the diameter of the second liquid guide holes 1213-2, a liquid supply speed of the first liquid guide holes 1213-1 is greater than a liquid supply speed of the second liquid guide holes 1213-2, and the first atomization temperature of the first atomization region 1212a-1 is lower than the second atomization temperature of the second atomization region 1212a-2. Aerosols of different flavors are formed through atomization in the first atomization region 1212a-1 and the second atomization region 1212a-2 respectively, and the aerosols of different flavors are mixed and are inhaled by a user.

In the embodiment, a portion of the heating element is arranged in the first atomization region 1212a-1, and the other portion of the heating element is arranged in the second atomization region 1212a-2. In response to receiving an inhaling signal, the main unit 2 controls the heating element to start to generate heat. The diameter of the first liquid guide holes 1213-1 is greater than the diameter of the second liquid guide holes 1213-2, a liquid supply speed of the first liquid guide holes 1213-1 is greater than a liquid supply speed of the second liquid guide holes 1213-2, and the first atomization temperature of the first atomization region 1212a-1 is lower than the second atomization temperature of the second atomization region 1212a-2. Specifically, in the embodiment, the first atomization temperature ranges from 200° C. to 250° C., and the second atomization temperature ranges from 250° C. to 350° C.

### Embodiment 3

The structure of an atomizer provided in Embodiment 3 is basically the same as the structure of the atomizer provided in Embodiment 2. Differences are as follows: the two liquid storage chambers 11 of the atomizer provided in Embodiment 2 are the first liquid storage chamber 11-1 and the second liquid storage chamber 11-2 in Embodiment 1 respectively, and correspondingly store the first medium to be atomized and the second medium to be atomized. The two sub-substrates of the substrate 121 are the first sub-substrate 121-1 and the second sub-substrate 121-2 in Embodiment 1 respectively. Two liquid storage chambers 11 of the atomizer provided in Embodiment 3 are the first liquid storage chamber 11-1 and the third liquid storage chamber 11-3 in Embodiment 1 respectively, and correspondingly store the first medium to be atomized and the third medium to be atomized. Two sub-substrates of a substrate 121 are the first sub-substrate 121-1 and the third sub-substrate 121-3 in Embodiment 1 respectively.

Specifically, a boiling point of the first medium to be atomized ranges from 20° C. to 250° C. A boiling point of the third medium to be atomized ranges from 400° C. to 600° C. The first medium to be atomized includes propylene glycol, glycerol, and a low-boiling-point aroma substance. The third medium to be atomized includes a sweetening agent. The first sub-substrate 121-1 has a plurality of first liquid guide holes 1213-1, and the third sub-substrate 121-3 has a plurality of third liquid guide holes 1213-3. The diameter of the first liquid guide holes 1213-1 is greater than or equal to 20 μm, and the diameter of the third liquid guide holes 1213-3 is greater than or equal to 20 μm. Moreover, the diameter of the third liquid guide holes 1213-3 is greater than the diameter of the first liquid guide holes 1213-1.

In the embodiment, the heating element includes a first heating sub-element and a third heating sub-element that are independent of each other. The first heating sub-element is arranged in the first atomization region 1212a-1. The third heating sub-element is arranged in the third atomization region 1212a-3. In response to receiving an inhaling signal, the main unit 2 controls the first heating sub-element and the third heating sub-element to start to generate heat. Power of the third heating sub-element is greater than power of the first heating sub-element. Since the third heating sub-element starts to generate heat in advance, the third atomization temperature of the third atomization region 1212a-3 is higher than the first atomization temperature. Specifically, in the embodiment, the first atomization temperature ranges from 200° C. to 250° C., and the third atomization temperature ranges from 400° C. to 550° C.

### Embodiment 4

The structure of an atomizer provided in Embodiment 4 is basically the same as the structure of the atomizer provided in Embodiment 2. Differences are as follows: the two liquid storage chambers 11 of the atomizer provided in Embodiment 2 are the first liquid storage chamber 11-1 and the second liquid storage chamber 11-2 in Embodiment 1 respectively, and correspondingly store the first medium to be atomized and the second medium to be atomized. The two sub-substrates of the substrate 121 are the first sub-substrate 121-1 and the second sub-substrate 121-2 in Embodiment 1 respectively. Two liquid storage chambers 11 of the atomizer provided in Embodiment 4 are the second liquid storage chamber 11-2 and the third liquid storage chamber 11-3 in Embodiment 1 respectively, and correspondingly store the second medium to be atomized and the third medium to be atomized. Two sub-substrates of a substrate 121 are the second sub-substrate 121-2 and the third sub-substrate 121-3 in Embodiment 1 respectively.

Specifically, a boiling point of the second medium to be atomized ranges from 250° C. to 360° C. A boiling point of the third medium to be atomized ranges from 400° C. to 600° C. The second medium to be atomized includes propylene glycol, glycerol, and a high-boiling-point aroma substance. The third medium to be atomized includes a sweetening agent. The second sub-substrate 121-2 has a plurality of second liquid guide holes 1213-2, and the third sub-substrate 121-3 has a plurality of third liquid guide holes 1213-3. The diameter of the second liquid guide holes 1213-2 is less than or equal to 20 μm, and the diameter of the third liquid guide holes 1213-3 is greater than or equal to 20 μm. Moreover, the diameter of the third liquid guide holes 1213-3 is greater than the diameter of the second liquid guide holes 1213-2.

In the embodiment, the heating element includes a second heating sub-element and a third heating sub-element that are independent of each other. The second heating sub-element is arranged in the second atomization region 1212a-2. The third heating sub-element is arranged in the third atomization region 1212a-3. In response to receiving an inhaling signal, the main unit 2 controls the third heating sub-element to first start to generate heat for a period of time. Then, the main unit 2 controls the second heating sub-element to start to generate heat. Since the third heating sub-element starts to generate heat in advance, the third atomization temperature of the third atomization region 1212a-3 is higher than the second atomization temperature. Specifically, in the embodiment, the second atomization temperature ranges from 250° C. to 350° C., and the third atomization temperature ranges from 400° C. to 550° C.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. An atomizer, comprising:
a plurality of liquid storage chambers, media to be atomized being stored in the plurality of liquid storage chambers, and different media to be atomized being stored in at least some liquid storage chambers of the plurality of liquid storage chambers; and
a heating assembly comprising a substrate, the substrate having a liquid absorbing surface and an atomization surface that are oppositely arranged, the substrate having a plurality of liquid guide holes configured to guide the media to be atomized from the liquid absorbing surface to the atomization surface,
wherein the atomization surface comprises a plurality of atomization regions, and the plurality of liquid storage chambers and the plurality of atomization regions are arranged in a one-to-one correspondence manner,
wherein the heating assembly comprises a heating element arranged on the atomization surface, or at least a part of the substrate has an electrically-conductive heating capability so as to serve as the heating element, and
wherein the heating element configured to heat the plurality of atomization regions to different atomization temperatures.

2. The atomizer of claim 1, wherein the plurality of liquid storage chambers comprises two liquid storage chambers, the two liquid storage chambers comprising a first liquid storage chamber and a second liquid storage chamber,
wherein a first medium to be atomized is stored in the first liquid storage chamber, and a second medium to be atomized is stored in the second liquid storage chamber,
wherein a boiling point of the first medium to be atomized is lower than a boiling point of the second medium to be atomized,
wherein the substrate comprises a first sub-substrate and a second sub-substrate that are connected to each other, the first sub-substrate has a first atomization region, and the second sub-substrate has a second atomization region,
wherein the first liquid storage chamber is arranged corresponding to the first atomization region, and the second liquid storage chamber is arranged corresponding to the second atomization region,
wherein the heating element is configured to heat the first atomization region to a first atomization temperature, and heat the second atomization region to a second atomization temperature, the first atomization temperature being lower than the second atomization temperature, and
wherein the first atomization temperature is an average temperature of the first atomization region, and the second atomization temperature is an average temperature of the second atomization region.

3. The atomizer of claim 2, wherein the boiling point of the first medium to be atomized ranges from 20° C. to 250° C., and the boiling point of the second medium to be atomized ranges from 250° C. to 360° C.,
wherein the first sub-substrate has a plurality of first liquid guide holes, and the second sub-substrate has a plurality of second liquid guide holes,
wherein a diameter of the first liquid guide holes is greater than or equal to 20 μm, and a diameter of the second liquid guide holes is less than or equal to 30 μm, and
wherein the first sub-substrate and the second sub-substrate satisfy one or more of the following conditions (1) to (4):
(1) the diameter of the first liquid guide holes is greater than the diameter of the second liquid guide holes;
(2) a ratio of a thickness of the first sub-substrate to the diameter of the first liquid guide holes is less than a ratio of a thickness of the second sub-substrate to the diameter of the second liquid guide holes;
(3) a length of the first liquid guide holes is less than a length of the second sub-substrate; and
(4) a porosity of the first sub-substrate is greater than a porosity of the second sub-substrate.

4. The atomizer of claim 3, wherein the first medium to be atomized comprises propylene glycol, glycerol, and a low-boiling-point aroma substance,
wherein the second medium to be atomized comprises propylene glycol, glycerol, and a high-boiling-point aroma substance,
wherein contents of the propylene glycol and the glycerol in the first medium to be atomized are different from contents of the propylene glycol and the glycerol in the second medium to be atomized,
wherein the diameter of the first liquid guide holes is greater than or equal to 30 μm, and the diameter of the second liquid guide holes is less than or equal to 20 μm, and
wherein the ratio of the thickness of the first sub-substrate to the diameter of the first liquid guide holes is less than 10:1, and a ratio of the thickness of the second sub-substrate to the diameter of the second liquid guide holes is greater than 10 1.

5. The atomizer of claim 4, wherein a content of the propylene glycol in the first medium to be atomized is greater than a content of the glycerol,
wherein a content of the propylene glycol in the second medium to be atomized is less than a content of the glycerol,
wherein the low-boiling-point aroma substance comprises nicotine or nicotine salt, and
wherein the high-boiling-point aroma substance comprises a plant extract.

6. The atomizer of claim 2, wherein the boiling point of the first medium to be atomized ranges from 20° C. to 250° C.; the boiling point of the second medium to be atomized ranges from 400° C. to 600° C.; the first sub-substrate has the plurality of first liquid guide holes, and the second sub-substrate has the plurality of second liquid guide holes; the diameter of the first liquid guide holes is greater than or equal to 20 μm, and the diameter of the second liquid guide holes is greater than or equal to 20 μm; and the diameter of the second liquid guide holes is greater than the diameter of the first liquid guide holes, or
wherein the boiling point of the first medium to be atomized ranges from 250° C. to 360° C.; the boiling point of the second medium to be atomized ranges from 400° C. to 600° C.; the first sub-substrate has the plurality of first liquid guide holes, and the second sub-substrate has the plurality of second liquid guide holes; the diameter of the first liquid guide holes is less than or equal to 20 μm, and the diameter of the second liquid guide holes is greater than or equal to 20 μm; and the diameter of the second liquid guide holes is greater than the diameter of the first liquid guide holes.

7. The atomizer of claim 6, wherein the boiling point of the first medium to be atomized ranges from 20° C. to 250° C.; the first medium to be atomized comprises propylene glycol, glycerol, and a low-boiling-point aroma substance; and the second medium to be atomized comprises a sweetening agent, or
wherein the boiling point of the first medium to be atomized ranges from 250° C. to 360° C.; the first medium to be atomized comprises propylene glycol, glycerol, and a high-boiling-point aroma substance; and the second medium to be atomized comprises a sweetening agent.

8. The atomizer of claim 1, wherein the plurality of liquid storage chambers comprises three liquid storage chambers, the comprises three liquid storage chambers comprising a first liquid storage chamber, a second liquid storage chamber, and a third liquid storage chamber,
wherein a first medium to be atomized is stored in the first liquid storage chamber, a second medium to be atomized is stored in the second liquid storage chamber, and a third medium to be atomized is stored in the third liquid storage chamber,
wherein a boiling point of the first medium to be atomized is lower than a boiling point of the second medium to be atomized, and the boiling point of the second medium to be atomized is lower than a boiling point of the third medium to be atomized,
wherein the substrate comprises a first sub-substrate, a second sub-substrate, and a third sub-substrate that are connected to each other, the first sub-substrate has a first atomization region, the second sub-substrate has a second atomization region, and the third sub-substrate has a third atomization region,
wherein the first liquid storage chamber is arranged corresponding to the first atomization region, the second liquid storage chamber is arranged corresponding to the second atomization region, and the third liquid storage chamber is arranged corresponding to the third atomization region,
wherein the heating element is configured to heat the first atomization region to a first atomization temperature, heat the second atomization region to a second atomization temperature, and heat the third atomization region to a third atomization temperature,
wherein the first atomization temperature is lower than the second atomization temperature, and the second atomization temperature is lower than the third atomization temperature, and
wherein the first atomization temperature is an average temperature of the first atomization region, the second atomization temperature is an average temperature of the second atomization region, the third atomization temperature is an average temperature of the third atomization region.

9. The atomizer of claim 8, wherein the boiling point of the first medium to be atomized ranges from 20° C. to 250° C., the boiling point of the second medium to be atomized ranges from 250° C. to 360° C., and the boiling point of the third medium to be atomized ranges from 400° C. to 600° C.;
wherein the first sub-substrate has a plurality of first liquid guide holes, the second sub-substrate has a plurality of second liquid guide holes, and the third sub-substrate has a plurality of third liquid guide holes;
wherein the diameter of the first liquid guide holes is greater than or equal to 20 μm, the diameter of the second liquid guide holes is less than or equal to 30 μm, and the diameter of the third liquid guide holes is greater than 20 μm;
wherein the diameter of the third liquid guide holes is greater than both the diameter of the first liquid guide holes and the diameter of the second liquid guide holes; and
wherein the first sub-substrate and the second sub-substrate satisfy one or more of the following conditions (1) to (4):
(1) the diameter of the first liquid guide holes is greater than the diameter of the second liquid guide holes;
(2) a ratio of a thickness of the first sub-substrate to the diameter of the first liquid guide holes is less than a ratio of a thickness of the second sub-substrate to the diameter of the second liquid guide holes;
(3) a length of the first liquid guide holes is less than a length of the second sub-substrate; and
(4) a porosity of the first sub-substrate is greater than a porosity of the second sub-substrate.

10. The atomizer of claim 9, wherein the first medium to be atomized comprises propylene glycol, glycerol, and a low-boiling-point aroma substance,
wherein the second medium to be atomized comprises propylene glycol, glycerol, and a high-boiling-point aroma substance, and the third medium to be atomized comprises a sweetening agent,
wherein contents of the propylene glycol and the glycerol in the first medium to be atomized are different from contents of the propylene glycol and the glycerol in the second medium to be atomized,
wherein the diameter of the first liquid guide holes is greater than or equal to 30 μm, the diameter of the second liquid guide holes is less than or equal to 20 μm, and the diameter of the third liquid guide holes is greater than 30 μm, and
wherein a ratio of the thickness of the first sub-substrate to the diameter of the first liquid guide holes is less than 10:1, a ratio of the thickness of the second sub-substrate to the diameter of the second liquid guide holes is greater than 10:1, and a ratio of the thickness of the third sub-substrate to the diameter of the third liquid guide holes is less than 8:1.

11. The atomizer of claim 8, wherein the first sub-substrate, the second sub-substrate, and the third sub-substrate comprise dense substrates, and the first liquid guide holes, the second liquid guide holes and the third liquid guide holes comprise through holes penetrating the liquid absorbing surface and the atomization surface, or
wherein some of the first sub-substrate, the second sub-substrate, and the third sub-substrate comprise dense substrates, and an other part of the first sub-substrate, the second sub-substrate, and the third sub-substrate comprise cellular substrates, the liquid guide holes in the dense substrates being through holes penetrating the liquid absorbing surface and the atomization surface, the liquid guide holes in the cellular substrates being disordered holes of the cellular substrates.

12. The atomizer of claim 2, wherein the heating element is arranged merely in the second atomization region, or
wherein the heating element comprises a heating portion and a heat conduction portion that are connected to each other, and the heating portion is arranged merely in the second atomization region, and the heat conduction portion is at least partially arranged in the first atomization region, or
wherein the heating element comprises a first heating portion and a second heating portion that are connected to each other, the first heating portion is arranged in the first atomization region, and the second heating portion is arranged in the second atomization region; and a resistance of the first heating portion is different from a resistance of the second heating portion, and/or a heat conductivity coefficient of material of the first heating portion is different from a heat conductivity coefficient of material of the second heating portion, or
wherein the heating element comprises a first heating sub-element and a second heating sub-element that are independent of each other, the first heating sub-element is arranged in the first atomization region, and the second heating sub-element is arranged in the second atomization region.

13. The atomizer of claim 8, wherein the first atomization region and the third atomization region are located on two opposite sides of the second atomization region respectively, and the heating element is arranged merely in the second atomization region, or
wherein the heating element comprises a heating portion and a heat conduction portion that are connected to each other, and the heating portion is arranged merely in the second atomization region, and the heat conduction portion is at least partially arranged in the first atomization region and/or the third atomization region, or
wherein the heating element comprises a first heating sub-portion, a second heating sub-portion, and a third heating sub-portion that are connected to each other, the first heating sub-portion is arranged in the first atomization region, the second heating sub-portion is arranged in the second atomization region, the third heating sub-portion is arranged in the third atomization region, the first heating sub-portion, the second heating sub-portion, and the third heating sub-portion have different resistances, or a heat conductivity coefficient of material of the first heating sub-portion, a heat conductivity coefficient of material of the second heating sub-portion, and a heat conductivity coefficient of material of the third heating sub-portion are different, or
wherein the heating element comprises a first heating sub-element, a second heating sub-element, and a third heating sub-element that are independent of each other, the first heating sub-element is arranged in the first atomization region, the second heating sub-element is arranged in the second atomization region, and the third heating sub-element is arranged in the third atomization region.

14. The atomizer of claim 1, wherein the substrate comprises a dense substrate, and the plurality of the liquid guide holes are arranged in an array,
wherein the heating element comprises a plurality of micro heating components, and the plurality of micro heating components are arranged in an array, and
wherein each micro heating component of the plurality of micro heating components is arranged around at least one liquid guide hole, and
wherein the micro heating components in each row and/or column are independent of each other.

15. The atomizer of claim 1, further comprising:
a plurality of sensors arranged on the substrate,
wherein the plurality of sensors and the plurality of atomization regions are arranged in a one-to-one correspondence manner.

16. The atomizer of claim 15, wherein the substrate comprises dense material,
wherein the liquid guide holes are through holes penetrating the liquid absorbing surface and the atomization surface, and
wherein the sensors are arranged on walls of the liquid guide holes.

17. The atomizer of claim 1, wherein the plurality of the atomization regions are arranged in parallel or in a ring.

18. An electronic atomization device, comprising:
the atomizer of claim 1; and
a main unit configured to provide electric energy for a heating assembly of the atomizer to work, and to control the heating assembly of the atomizer to atomize a medium to be atomized.
